(19) United States
(12) Patent Application Publication
(10) Pub. No.: US 2013/0127909 A1
(43) Pub. Date: May 23, 2013

(54) Multiple simultaneous biometric data acquisition and display system and method of use

(71) Applicant: VizKinect Inc., Reno, NV (US)

(72) Inventors: Ronald G. Nichols, Reno, NV (US); Tristan Rasmussen, Reno, NV (US)

(73) Assignee: VizKinect Inc., Reno, NV (US)

(21) Appl. No.: 13/694,349

(22) Filed: Nov. 23, 2012

Related U.S. Application Data
(60) Provisional application No. 61/563,307, filed on Nov. 23, 2011.

(51) Int. Cl. G06T 11/00

(52) U.S. Cl. CPC G06T 11/00
USPC 345/638

(57) ABSTRACT

Systems and methods are disclosed for collecting and displaying biometric data associated with multiple individuals in real-time, including multiple computer stations, hardware for collecting raw biometric data, software for calibrating biometric devices, software for normalizing and transferring biometric data, and software for processing and displaying biometric data. In one embodiment, the system further includes software for generating graphical indicators that correspond to specific locations on a stimulus video, overlaying those graphical indicators on individual video frames of the stimulus video, and displaying the overlaid stimulus video. The system further includes software enabling real-time interaction with the display of the biometric data based on segregating participants according to meta-data values.

### CROSS-REFERENCE TO RELATED APPLICATIONS

The present application for patent claims priority through the applicant's prior provisional patent application, entitled A Method And System For Multiple Simultaneous Acquisition And Display Of Biometric Data, Ser. No. 61/563,307, filed Nov. 23, 2011, which provisional application is hereby incorporated by reference in its entirety.

### COMPUTER PROGRAM LISTING APPENDIX

This application includes a transmittal under 37 C.F.R. Sec. 1.52(e) of a Computer Program Listing Appendix stored on each of two duplicate compact disks which accompany this Specification. Each disk contains computer program listings which illustrate implementations of the invention, and is herein incorporated by reference. The computer program in the Computer Program Listing Appendix is written in C#. The listings are recorded as ASCII text in IBM PC, MS Windows compatible files which have the directory structures, creation dates and times, sizes (in bytes), and names listed below:

Files Contained on Computer Program Listing Appendix

| File No. | File Name | Dated Created | File Size (Bytes) |
|---|---|---|---|
| 1 | VizKinect.sln | Nov. 19, 2012 | 16562 |
| | ./EyeTech: | ./EyeTech: | ./EyeTech: |
| | EyeTech | Nov. 19, 2012 | 204 |
| 2 | EyeTech.sln | Nov. 19, 2012 | 1622 |
| 3 | EyeTech.suo | Nov. 19, 2012 | 34221 |
| | ./EyeTech/EyeTech: | ./EyeTech/EyeTech: | ./EyeTech/EyeTech: |
| 4 | EyeTech.csproj | Nov. 19, 2012 | 4664 |
| 5 | EyeTech.csproj.user | Nov. 19, 2012 | 940 |
| 6 | EyeTechVT2EyeTracker. | Nov. 19, 2012 | 23148 |
| | cs | | |
| | Properties | Nov. 19, 2012 | 102 |
| | ./EyeTech/EyeTech/Properties: | ./EyeTech/EyeTech/Properties: | ./EyeTech/EyeTech/Properties: |
| 7 | AssemblyInfo.cs | Nov. 19, 2012 | 2155 |
| | ./EyeTechAPIWrapper: | ./EyeTechAPIWrapper: | ./EyeTechAPIWrapper: |
| | EyeTechAPIWrapper | Nov. 19, 2012 | 170 |
| 8 | EyeTechAPIWrapper.sln | Nov. 19, 2012 | 1652 |
| 9 | EyeTechAPIWrapper.suo | Nov. 19, 2012 | 30976 |
| | ./EyeTechAPIWrapper/ | ./EyeTechAPIWrapper/ | ./EyeTechAPIWrapper/ |
| | EyeTechAPIWrapper: | EyeTechAPIWrapper: | EyeTechAPIWrapper: |
| 10 | EyeTechAPI.cs | Nov. 19, 2012 | 3772 |
| 11 | EyeTechAPIWrapper.csproj | Nov. 19, 2012 | 3194 |
| | Properties | Nov. 19, 2012 | 102 |
| | ./EyeTechAPIWrapper/ | ./EyeTechAPIWrapper/ | ./EyeTechAPIWrapper/ |
| | EyeTechAPIWrapper/Properties: | EyeTechAPIWrapper/Properties: | EyeTechAPIWrapper/Properties: |
| 12 | AssemblyInfo.cs | Nov. 19, 2012 | 2175 |
| | ./EyeTechEnums: | ./EyeTechEnums: | ./EyeTechEnums: |
| | EyeTechEnums | Nov. 19, 2012 | 170 |
| 13 | EyeTechEnums.sln | Nov. 19, 2012 | 1641 |
| 14 | EyeTechEnums.suo | Nov. 19, 2012 | 25611 |
| | ./EyeTechEnums/EyeTech | ./EyeTechEnums/EyeTech | ./EyeTechEnums/EyeTech |
| | Enums: | Enums: | Enums: |
| 15 | EyeTechEnums.cs | Nov. 19, 2012 | 4587 |
| 16 | EyeTechEnums.csproj | Nov. 19, 2012 | 3031 |
| | Properties | Nov. 19, 2012 | 102 |
| | ./EyeTechEnums/EyeTech | ./EyeTechEnums/EyeTech | ./EyeTechEnums/EyeTech |
| | Enums/Properties: | Enums/Properties: | Enums/Properties: |
| 17 | AssemblyInfo.cs | Nov. 19, 2012 | 2165 |
| | ./EyeTechStructs: | ./EyeTechStructs: | ./EyeTechStructs: |
| | EyeTechStructs | Nov. 19, 2012 | 238 |
| 18 | EyeTechStructs.sln | Nov. 19, 2012 | 1643 |
| 19 | EyeTechStructs.suo | Nov. 19, 2012 | 30079 |
| | ./EyeTechStructs/Eye | ./EyeTechStructs/Eye | ./EyeTechStructs/Eye |
| | TechStructs: | TechStructs: | TechStructs: |
| 20 | APIEyeTechEyeTracker. | Nov. 19, 2012 | 39434 |
| | cs | | |
| 21 | EyeTechAPI.cs | Nov. 19, 2012 | 3881 |
| 22 | EyeTechStructs.cs | Nov. 19, 2012 | 5117 |
| 23 | EyeTechStructs.csproj | Nov. 19, 2012 | 3037 |
| | Properties | Nov. 19, 2012 | 102 |
| | ./EyeTechStructs/Eye | ./EyeTechStructs/Eye | ./EyeTechStructs/Eye |
| | TechStructs/Properties: | TechStructs/Properties: | TechStructs/Properties: |
| 24 | AssemblyInfo.cs | Nov. 19, 2012 | 2169 |
| | ./MiraMetrix: | ./MiraMetrix: | ./MiraMetrix: |
| | MiraMetrix | Nov. 19, 2012 | 170 |
| 25 | MiraMetrix.sln | Nov. 19, 2012 | 1631 |
| 26 | MiraMetrix.suo | Nov. 19, 2012 | 25927 |
| | ./MiraMetrix/MiraMetrix: | ./MiraMetrix/MiraMetrix: | ./MiraMetrix/MiraMetrix: |
| 27 | MiraMetrix.csproj | Nov. 19, 2012 | 3388 |
| 28 | MirametrixS2EyeTracker. | Nov. 19, 2012 | 14429 |
| | cs | | |
| | Properties | Nov. 19, 2012 | 102 |
| | ./MiraMetrix/MiraMetrix/ | ./MiraMetrix/MiraMetrix/ | ./MiraMetrix/MiraMetrix/ |
| | Properties: | Properties: | Properties: |
| 29 | AssemblyInfo.cs | Nov. 19, 2012 | 2161 |
| | ./VKData: | ./VKData: | ./VKData: |
| | Entities | Nov. 19, 2012 | 442 |
| 30 | InvalidVersionException. | Nov. 19, 2012 | 1766 |
| | cs | | |
| 31 | Model.cs | Nov. 19, 2012 | 9994 |
| 32 | ParticipantDataDerived | Nov. 19, 2012 | 2349 |
| | NumberRange.cs | | |
| | Properties | Nov. 19, 2012 | 102 |
| 33 | VKData.csproj | Nov. 19, 2012 | 4822 |
| 34 | VKData.csproj.user | Nov. 19, 2012 | 940 |
| | ./VKData/Entities: | ./VKData/Entities: | ./VKData/Entities: |
| 35 | AOI.cs | Nov. 19, 2012 | 3365 |
| 36 | AOIKeyFrame.cs | Nov. 19, 2012 | 12419 |
| 37 | AOIPoint.cs | Nov. 19, 2012 | 1494 |
| 38 | BiometricData.cs | Nov. 19, 2012 | 1175 |
| 39 | BiometricDataGroup.cs | Nov. 19, 2012 | 1607 |
| 40 | Participant.cs | Nov. 19, 2012 | 4210 |
| 41 | ParticipantData.cs | Nov. 19, 2012 | 1112 |
| 42 | ParticipantMeta.cs | Nov. 19, 2012 | 2184 |
| 43 | ParticipantStudy.cs | Nov. 19, 2012 | 1769 |
| 44 | Project.cs | Nov. 19, 2012 | 3846 |
| 45 | VKVersion.cs | Nov. 19, 2012 | 1242 |
| | ./VKData/Properties: | ./VKData/Properties: | IVKData/Properties: |
| 46 | AssemblyInfo.cs | Nov. 19, 2012 | 2135 |
| | ./VKManager: | ./VKManager: | ./VKManager: |
| 47 | App.config | Nov. 19, 2012 | 1116 |
| 48 | App.xaml | Nov. 19, 2012 | 2035 |
| 49 | App.xaml.cs | Nov. 19, 2012 | 2886 |
| 50 | DefaultMetaTemplate. | Nov. 19, 2012 | 1169 |
| | xml | | |
| 51 | IntroControl.xaml | Nov. 19, 2012 | 1567 |
| 52 | IntroControl.xaml.cs | Nov. 19, 2012 | 1736 |
| 53 | MainControl.xaml | Nov. 19, 2012 | 2670 |
| 54 | MainControl.xaml.cs | Nov. 19, 2012 | 4044 |
| 55 | MainWindow.xaml | Nov. 19, 2012 | 1325 |
| 56 | MainWindow.xaml.cs | Nov. 19, 2012 | 5944 |
| | Participants | Nov. 19, 2012 | 578 |
| | Properties | Nov. 19, 2012 | 238 |
| | RemoteStudy | Nov. 19, 2012 | 272 |
| | RunTest | Nov. 19, 2012 | 136 |
| | TabControls | Nov. 19, 2012 | 272 |
| 64 | VKManager.csproj | Nov. 19, 2012 | 14316 |
| 65 | VKManager.csproj.user | Nov. 19, 2012 | 1512 |
| 66 | app.manifest | Nov. 19, 2012 | 2977 |
| | ./VKManager/Participants: | ./VKManager/Participants: | ./VKManager/Participants: |
| 57 | IEditParticipantMeta.cs | Nov. 19, 2012 | 1012 |
| 58 | MetaEditWindow.xaml | Nov. 19, 2012 | 3350 |
| 59 | MetaEditWindow.xaml. | Nov. 19, 2012 | 4147 |
| | cs | | |
| 60 | MetaListWindow.xaml | Nov. 19, 2012 | 3064 |
| 61 | MetaListWindow.xaml. | Nov. 19, 2012 | 5820 |
| | cs | | |
| 62 | ParticipantEditCheckbox | Nov. 19, 2012 | 1554 |
| | Control.xaml | | |
| 63 | ParticipantEditCheckbox | Nov. 19, 2012 | 2209 |
| | Control.xaml.cs | | |
| 64 | ParticipantEditDateControl. | Nov. 19, 2012 | 1535 |
| | xaml | | |
| 65 | ParticipantEditDateControl. | Nov. 19, 2012 | 2011 |
| | xaml.cs | | |
| 66 | ParticipantEditDropdown | Nov. 19, 2012 | 1534 |
| | Control.xaml | | |
| 67 | ParticipantEditDropdown | Nov. 19, 2012 | 2338 |
| | Control.xaml.cs | | |
| 68 | ParticipantEditTextControl. | Nov. 19, 2012 | 1529 |
| | xaml | | |
| 69 | ParticipantEditTextControl. | Nov. 19, 2012 | 2151 |
| | xaml.cs | | |
| 70 | ParticipantEditWindow. | Nov. 19, 2012 | 2519 |
| | xaml | | |
| 71 | ParticipantEditWindow. | Nov. 19, 2012 | 8030 |
| | xaml.cs | | |
| | ./VKManager/Properties: | ./VKManager/Properties: | ./VKManager/Properties: |
| 72 | AssemblyInfo.cs | Nov. 19, 2012 | 2996 |
| 73 | Resources.Designer.cs | Nov. 19, 2012 | 3557 |
| 74 | Resources.resx | Nov. 19, 2012 | 6325 |
| 75 | Settings.Designer.cs | Nov. 19, 2012 | 1805 |
| 76 | Settings.settings | Nov. 19, 2012 | 914 |
| | ./VKManager/Remote | ./VKManager/Remote | ./VKManager/Remote |
| | Study: | Study: | Study: |
| 77 | CalibrateWindow.xaml | Nov. 19, 2012 | 3109 |
| 78 | CalibrateWindow.xaml. | Nov. 19, 2012 | 5356 |
| | cs | | |
| 79 | Listener.cs | Nov. 19, 2012 | 40603 |
| 80 | ParticipantStatus.cs | Nov. 19, 2012 | 7396 |
| 81 | RemoteStudySettings. | Nov. 19, 2012 | 3057 |
| | xaml | | |
| 82 | RemoteStudySettings. | Nov. 19, 2012 | 6258 |
| | xaml.cs | | |
| | ./VKManager/RunTest: | ./VKManager/RunTest: | ./VKManager/RunTest: |
| 83 | RunTestWindow.xaml | Nov. 19, 2012 | 2460 |
| 84 | RunTestWindow.xaml. | Nov. 19, 2012 | 8432 |
| | cs | | |
| | ./VKManager/TabControls: | ./VKManager/TabControls: | ./VKManager/TabControls: |
| 85 | ParticipantControl.xaml | Nov. 19, 2012 | 1663 |
| 86 | ParticipantControl.xaml. | Nov. 19, 2012 | 5965 |
| | cs | | |
| 87 | SettingsControl.xaml | Nov. 19, 2012 | 5506 |
| 88 | SettingsControl.xaml.cs | Nov. 19, 2012 | 5201 |
| 89 | StatusControl.xaml | Nov. 19, 2012 | 5897 |
| 90 | StatusControl.xaml.cs | Nov. 19, 2012 | 14636 |
| | ./VKPlayer: | ./VKPlayer: | ./VKPlayer: |
| 91 | App.config | Nov. 19, 2012 | 1116 |
| 92 | App.xaml | Nov. 19, 2012 | 2033 |
| 93 | App.xaml.cs | Nov. 19, 2012 | 2750 |
| 94 | MainWindow.xaml | Nov. 19, 2012 | 1211 |
| 95 | MainWindow.xaml.cs | Nov. 19, 2012 | 2833 |
| | Properties | Nov. 19, 2012 | 238 |
| 96 | VKPlayer.csproj | Nov. 19, 2012 | 6375 |
| 97 | VKPlayer.csproj.user | Nov. 19, 2012 | 1033 |
| | ./VKPlayer/Properties: | ./VKPlayer/Properties: | ./VKPlayer/Properties: |
| 98 | AssemblyInfo.cs | Nov. 19, 2012 | 2945 |
| 99 | Resources.Designer.cs | Nov. 19, 2012 | 3555 |
| 100 | Resources.resx | Nov. 19, 2012 | 6325 |
| 101 | Settings.Designer.cs | Nov. 19, 2012 | 1804 |
| 102 | Settings.settings | Nov. 19, 2012 | 914 |
| | ./VKRemoteStudy: | ./VKRemoteStudy: | ./VKRemoteStudy: |
| 103 | App.xaml | Nov. 19, 2012 | 1065 |
| 104 | App.xaml.cs | Nov. 19, 2012 | 1900 |
| 105 | MainWindow.xaml | Nov. 19, 2012 | 3372 |
| 106 | MainWindow.xaml.cs | Nov. 19, 2012 | 31669 |
| | Properties | Nov. 19, 2012 | 238 |
| 107 | VKRemoteStudy.csproj | Nov. 19, 2012 | 6274 |
| 108 | app.config | Nov. 19, 2012 | 2204 |
| 109 | app.manifest | Nov. 19, 2012 | 2977 |
| | ./VKRemoteStudy/Properties: | ./VKRemoteStudy/Properties: | ./VKRemoteStudy/Properties: |
| 110 | AssemblyInfo.cs | Nov. 19, 2012 | 2955 |
| 111 | Resources.Designer.cs | Nov. 19, 2012 | 3565 |
| 112 | Resources.resx | Nov. 19, 2012 | 6325 |
| 113 | Settings.Designer.cs | Nov. 19, 2012 | 2644 |
| 114 | Settings.settings | Nov. 19, 2012 | 1257 |
| | ./VKSensorManagers: | ./VKSensorManagers: | ./VKSensorManagers: |
| 115 | BiometricDevices.cs | Nov. 19, 2012 | 9114 |
| 116 | BiometricDevices.xml | Nov. 19, 2012 | 1495 |
| 117 | ChooseDevice.resx | Nov. 19, 2012 | 6530 |
| 118 | ChooseDeviceUserControl. | Nov. 19, 2012 | 1251 |
| | xaml | | |
| 119 | ChooseDeviceUserControl. | Nov. 19, 2012 | 1825 |
| | xaml.cs | | |
| 120 | Devices | Nov. 19, 2012 | 272 |
| 121 | IBiometricDevice.cs | Nov. 19, 2012 | 1249 |
| 122 | ICentralizedBiometric | Nov. 19, 2012 | 966 |
| | Device.cs | | |
| | Properties | Nov. 19, 2012 | 102 |
| 123 | VKSensorManagers.cs | Nov. 19, 2012 | 4427 |
| | proj | | |
| | ./VKSensorManagers/ | ./VKSensorManagers/ | ./VKSensorManagers/ |
| | Devices: | Devices: | Devices: |
| 124 | DebugEyeTracker.cs | Nov. 19, 2012 | 2778 |
| 125 | EyeTechEyeTracker.cs | Nov. 19, 2012 | 29976 |
| 126 | MinionEyeTracker.cs | Nov. 19, 2012 | 13474 |
| 127 | MirametrixS2EyeTracker. | Nov. 19, 2012 | 12015 |
| | cs | | |
| 128 | TestEyeTracker.cs | Nov. 19, 2012 | 32222 |
| 129 | TestSkinSensor.cs | Nov. 19, 2012 | 2508 |
| | ./VKSensorManagers/ | ./VKSensorManagers/ | ./VKSensorManagers/ |
| | Properties: | Properties: | Properties: |
| 130 | AssemblyInfo.cs | Nov. 19, 2012 | 2155 |
| | ./VKVideoRendering: | ./VKVideoRendering: | ./VKVideoRendering: |
| | AOIs | Nov. 19, 2012 | 374 |
| 131 | ConcurrentList.cs | Nov. 19, 2012 | 6697 |
| 132 | DSHelpers.cs | Nov. 19, 2012 | 27138 |
| 133 | DataRenderer.cs | Nov. 19, 2012 | 7790 |
| 134 | ExportVideo.xaml | Nov. 19, 2012 | 1630 |
| 135 | ExportVideo.xaml.cs | Nov. 19, 2012 | 5628 |
| 136 | FilterExporter.cs | Nov. 19, 2012 | 17568 |
| 137 | IVideoCallback.cs | Nov. 19, 2012 | 1227 |
| 138 | OutputControl.xaml | Nov. 19, 2012 | 5704 |
| 139 | OutputControl.xaml.cs | Nov. 19, 2012 | 10669 |
| 140 | ParticipantWrapper.cs | Nov. 19, 2012 | 8975 |
| | Properties | Nov. 19, 2012 | 238 |
| | Resources | Nov. 19, 2012 | 102 |
| 141 | SampleGrabberCallback. | Nov. 19, 2012 | 3680 |
| | cs | | |
| 142 | SliderWithDraggingEvents. | Nov. 19, 2012 | 1739 |
| | cs | | |
| 143 | StudyRenderer.cs | Nov. 19, 2012 | 12596 |
| 144 | UserGridControl.xaml | Nov. 19, 2012 | 1984 |
| 145 | UserGridControl.xaml. | Nov. 19, 2012 | 12229 |
| | cs | | |
| 146 | VKVideoRendering.csproj | Nov. 19, 2012 | 8874 |
| 147 | VideoFileWriter.cs | Nov. 19, 2012 | 8239 |
| 148 | VideoFrameTracker.cs | Nov. 19, 2012 | 2345 |
| 149 | VideoManager.cs | Nov. 19, 2012 | 6844 |
| 150 | VideoRenderer.cs | Nov. 19, 2012 | 16407 |
| 151 | media.prx | Nov. 19, 2012 | 3428 |
| | ./VKVideoRendering/AOIs: | ./VKVideoRendering/AOIs: | ./VKVideoRendering/AOIs: |
| 152 | AOIList.xaml | Nov. 19, 2012 | 9255 |
| 153 | AOIList.xaml.cs | Nov. 19, 2012 | 13697 |
| 154 | AOIRenderer.cs | Nov. 19, 2012 | 5171 |
| 155 | CreateAOIWindow.xaml | Nov. 19, 2012 | 2647 |
| 156 | CreateAOIWindow.xaml. | Nov. 19, 2012 | 4072 |
| | cs | | |
| 157 | ExportAOI.xaml | Nov. 19, 2012 | 1831 |
| 158 | ExportAOI.xaml.cs | Nov. 19, 2012 | 15395 |
| 159 | KeyFrameSettingsWindow. | Nov. 19, 2012 | 1660 |
| | xaml | | |
| 160 | KeyFrameSettingsWindow. | Nov. 19, 2012 | 1678 |
| | xaml.cs | | |
| | ./VKVideoRendering/Properties: | ./VKVideoRendering/Properties: | ./VKVideoRendering/Properties: |
| 161 | AssemblyInfo.cs | Nov. 19, 2012 | 3007 |
| 162 | Resources.Designer.cs | Nov. 19, 2012 | 3571 |
| 163 | Resources.resx | Nov. 19, 2012 | 6325 |
| 164 | Settings.Designer.cs | Nov. 19, 2012 | 1812 |
| 165 | Settings.settings | Nov. 19, 2012 | 914 |
| | ./VKVideoRendering/Resources: | ./VKVideoRendering/Resources: | ./VKVideoRendering/Resources: |
| 166 | GlassButton.xaml | Nov. 19, 2012 | 13186 |

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

The files included in the Computer Program Listing Appendix are subject to copyright protection and any use thereof, other than as part of the reproduction of the patent document or the patent disclosure, is strictly prohibited.

### FIELD OF TECHNOLOGY

The present invention relates to the acquisition and display of biometric data and more particularly to a system and method for overlaying multiple normalized biometric data streams on a stimulus video in realtime.

### BACKGROUND

The collection and analysis of biometric data is useful for a variety of purposes in areas including, but not limited to, attention training, marketing analysis, novice-to-expert training, and medical diagnosis. A variety of devices and technologies have been developed for the collection of biometric data from participants. Data collected include, but are not limited to, eye-tracking data, facial recognition, skin temperature, skin conductance and pulse rate. The increased availability of these collection devices has given rise to the need for methods and system for the analysis and presentation of this data.

Conventional methods and systems in this field captured a single family of raw biometric data (e.g. eye-tracking data) from a participant and stored that data for later processing and presentation. This one-dimensional approach failed to account for the value of including data from multiple participants simultaneously. It also failed to consider the value of displaying aggregated results in real time. The conclusions drawn from such a one-dimensional analysis lacked accuracy, supportability and repeatability. In addition, it was costly to attempt to collect data serially from single participants, especially in cases where tests needed to be repeated over an extended period of time.

Traditional methods typically stored data either on a storage medium physically incorporated into the biometric collection device, or on a workstation associated with the device. As a result, an additional manual step was required to export and import the collected data from the isolated storage medium to a shared storage medium for aggregated processing, analysis and presentation. This added step was not only time consuming, labor-intensive and error-prone, but made synchronization potentially difficult with respect to associating the collected biometric data with the dynamic environmental stimulus.

Another disadvantage of these methods and systems was that typically they were coupled to a specific biometric input device. Each device on the market requires different levels and methods of calibration, and generates different raw data output. This resulted in end-to-end proprietary systems that were typically not capable of easily and efficiently capturing similar data from similar biometric capture devices, or dissimilar data from disparate biometric capture devices. As a result, there was significant manual data collection, processing and transformation required simply to reach the point where data was sufficiently normalized to enable basic data analysis. Vertical solutions with limited interfaces to a limited set of input devices and processing systems based on a static data model typically resulted in architectures that were very inefficient, costly, difficult to implement and lacking in robustness and extensibility.

A further disadvantage of these proprietary methods was a lack of consistency across presentation tools and drill-down capabilities within those tools. Data captured from disparate input devices was typically converted and normalized in order to be observed in aggregate form. The proprietary approach typically included a degree of manual involvement that was costly, complex and prone to error. Further, the ability to drill down into the biometric data by interacting with the presentation of the results is also limited to the presentation tool's awareness of the attributes obtained in the static aggregated data structures. The degree of modification required at the data level, as well as the development necessary to enable useful drill down for a particular test, was significant and often prohibitive in terms of time, expense and reusability. The proprietary approach typically involved substantial customization that made broad dynamic application of biometric capture and analysis unrealistic.

In addition, these methods and systems were not typically designed to support multiple simultaneous participants utilizing disparate biometric capture devices. In any given situation, participants receive a variety of environmental stimulus and generate layered biological responses to said stimulus. Traditional methods and systems managed a single data stream from a single participant and stored that data for later aggregation, structuring and analysis. Conclusions were then drawn from this single type of biometric data that were regarded as determinative. Further, the data model for this method and system was typically designed only to manage a single family of biometric data, such as eye-tracking data, and to leave no flexibility for capturing, structuring, relating and efficiently analyzing other related biometric data. The lack of a robust data model that can easily incorporate disparate biometric data severely limits the value of the results and the strength of conclusions drawn.

Display approaches were typically focused towards either a single user or an aggregation of all users, and did not enable the dynamic creation of user sets based on demographic data, metadata or multiple biometric data inputs. Further, it was standard practice to display the data in such a way that it obscured the underlying area of interest, as is the case when using heat maps, or in a manner that does not adequately identify distinctive qualities of participant subgroups based upon demographic or other biometric data. This information was used in complex post-collection processing to generate static charts, graphs or statistics, but lacked the flexibility to easily filter and segregate participants into subgroups across all dimensions, both for real-time display as well as for post-collection processing.

The design of the object model and data model in traditional systems typically failed to support the various data structures required to account for data collected from similar and dissimilar biometric devices, as well as for the collection and structuring of non-biometric data, such as demographic or environmental information. This is an unsurprising consequence of methods and systems where an input device was coupled to a specific data storage medium, which was then coupled to a specific set of processes dependent on the data structures contained therein, and where the presentation tools depended on a static set of objects or data structures generated from the stored data.

These traditional approaches were designed primarily to perform post collection aggregation, processing and display, resulting in significant lag-time between testing and presentation. This made it difficult to recognize relevant conditions under test and adjust or modify conditions in order to obtain the most valuable data for the purpose of drawing definitive conclusions. Additional tests had to be scheduled that typically involved gathering participants at different times and days, with control conditions unintentionally varied. This severely compromised the integrity of these additional test iterations and therefore the accuracy of the results obtained. The absence of real-time processing and presentation of aggregated data added to the complexity and risk in using these systems and methods.

Calibration of biometric devices was yet another time consuming element of attempting to perform studies with multiple participants. Each device had to be calibrated individually, which required either relying on the participant unfamiliar with the technology to execute the calibration, or the study proctor to physically attend to each machine to initiate and verify calibration. This error prone and time-intensive approach to device calibration was a disincentive to large scale multi-participant studies.

Traditional systems and methods did not provide a practical way to overlay a recorded stimulus with both a base set of biometric data and a participant's biometric data such that the divergence by the participant from the standard could be easily observed at every point in the test in real-time. Further, it was very complex to collect participant data over an extended period of time which made the accurate and consistent overlaying of data on a recorded stimulus and the identification of base biometric data difficult.

### BRIEF SUMMARY OF SOME ASPECTS OF THE DISCLOSURE

It is to be understood that this Brief Summary recites some aspects of the present disclosure, but there are other novel and advantageous aspects. They will become apparent as this specification proceeds. Variously achievable advantages of certain embodiments include those advantages discussed below, among others.

The applicants believe that they have discovered at least one or more of the problems and issues with prior art systems noted above as well as one or more advantages provided by differing embodiments of the multiple simultaneous biometric data acquisition and display system and method of use disclosed in this specification.

In some embodiments, a service is implemented that communicates with one or more biometric collection devices and transforms the data generated by said biometric collection devices into a normalized data structure. This normalized data structure can then be used to effectively decouple specific biometric collection devices from the data model, processing and presentation related to the biometric data. A method and system with the ability to capture similar data from similar biometric capture devices, or dissimilar data from disparate biometric capture devices without custom integration can create efficiencies, economies of scale, robustness and/or extensibility. Further, such a method and system can allow for the use of a variety of capture devices without dependence on a single'vendor or single type of biometric data. This device independence can enable the acquisition of meaningful results should a problem arise with the recording of the stimulus of any single device due to environmental factors such as light or temperature.

In some embodiments, data from multiple participants will be simultaneously collected, aggregated, structured, and processed in real-time. Remote study stations connected to biometric collection devices can perform pre-processing activities that normalize the biometric data ahead of transmission to study manager application residing on a single proctor station computer. This pre-processing allows the manager application on the proctor stations to dedicate its processing activities to the display of multiple data streams of biometric data in real-time. The accuracy of conclusions drawn from such a multi-dimensional analysis can be more accurate than a single dimension analysis, or one that can be dependent on serial administration and collection over time. The ability to execute a large-scale test with all participants involved concurrently can significantly reduce the cost of administering multi-user tests. Further, the time from test initiation to results can be significantly reduced, allowing for more immediate analysis and additional test iterations.

In some embodiments, data collection and real time interactive display of processed data occur simultaneously. This can allow the test administrator to recognize relevant conditions under test and adjust or modify said conditions in order to, on some embodiments, obtain the most valuable data for the purpose of drawing definitive conclusions. This interactivity in real-time can also allow the administrator to determine if there are any problems with the test system, configuration or administration such that, in some embodiments, additional iterations can be executed immediately without the additional cost or uncertainty that results from reconvening after a significant time lag. For example, the stakeholders monitoring the study in real-time can immediately determine if there is a trend with a particular demographic, or a general deficiency with the stimulus video. The stakeholder can then immediately move to the use of a different stimulus video that would address the particular deficiency or drill down into the demographic observation.

In some embodiments, simultaneous configuration, calibration and synchronization of disparate biometric data input devices with an environmental stimulus can be automated. Configuring, calibrating, and synchronizing a large number of disparate biometric collection devices simultaneously in a multi-user test scenario significantly reduce the time required to execute a test iteration, particularly where there is a large number of users. This also reduces the demands on the participants in terms of time and inconvenience. The ability to control and monitor all of these functions from a single study proctor application can reduce administrator error that otherwise results from manual involvement in repeated calibrations and synchronizations.

In some embodiments, a normalized intermediate data structure is used to aggregate demographic data, metadata, similar biometric data and dissimilar biometric data. Such a normalized structure can enable independence both in terms of biometric collection devices and in terms of presentation technologies. The ability to rely on a normalized data structure can significantly improve the extensibility of the system as a whole, as well as, in some embodiments, that of any interfacing technologies. Such a normalized model can further enable the integration of single stream data that would otherwise exist without necessarily aggregating relationships into an aggregated analytical model.

In some embodiments, a dynamic extensible data model is used to accommodate additional inputs from an expanding set of biometric collection devices, as well as additional meta-data parameters. This dynamic data model can allow for the collection of a set of expected and unexpected parameters, enabling, in some embodiments, a more substantial parameterized filtering and grouping of data, resulting in greater accuracy and flexibility. Further, a dynamic data model can significantly reduce the rigidity of the method and system, enabling functional expansion without significant customization.

In some embodiments, server-based data storage and processing are used, which can dramatically reduces the time required to transform, transfer and/or aggregate data, as well as reduce the potential difficulties associated with synchronizing collected biometric data with the dynamic environmental stimulus of the test environment. In addition, data processing of the aggregated data can be executed in a controlled fashion on a more processing-centric device or virtual device, which, in some embodiments, can avoid possible conflicts or deadlock conditions that can occur when processing for single streams occurs in isolation.

In some embodiments, a color-correlated, user-interactive, circle-based display overlay can be used to correlate biometric data with regions, areas and points of interest. The color-correlation can enable the interactive identification of filtered and segregated sub-groups of participants in real-time. Rather than using heat maps and gaze plots, in some embodiments, the use of color-correlated circles minimizes the tendency to excessively obscure the stimulus used for testing, while, in some embodiments, providing the administrators the ability clearly identify trends and patterns within a set or subset of test participants. Further, the interactive element of the circles can enable the administrator to click on a specific circle at a given gaze location to, for example, see related parametric data. This can provide instantaneous awareness of demographic and/or metadata attributes that may be involved in trending or patterning as they relate to regions, areas or points of interest.

In some embodiments, a color-correlated, user-interactive, circle-based display overlay provides support for the overlay of a recorded stimulus with both a base set of biometric data and a participant's biometric data such that the divergence by the participant from the standard is easily observed at every point in the test. This can simplify the aggregation of participant data over an extended period of time such that, in some embodiments, this data can be easily overlaid on a recorded stimulus and the base biometric data easily identified based upon color. This is of particular interest in the case of novice to expert training. For example, visual information is important during medical training. Studying doctor's eye movements is an innovative way to assess skills, particularly when comparing eye movement strategies between expert medical doctors and novices. This comparison may show important differences that can be used in the training process. The ability to see the divergence patterns of the novice as compared to that of the expert in real-time allows for immediate correction and the proper focusing of the training process.

In some embodiments, individual biometric data streams can be isolated in real-time. This can allow for the identification and possible correction of anomalous behavior within a multi-user test environment. This isolation capability can also be indicative of equipment malfunctions, allowing for said malfunction to be immediately addressed, thus, improving the quality, quantity and accuracy of data collected and results obtained through the exclusion of outliers.

There are other aspects and advantages of the invention and/or the preferred embodiments. They will become apparent to those skilled in the art as this specification proceeds. In this regard, it is to be understood that not all such aspects or advantages need be achieved to fall within the scope of the present invention, nor need all issues in the prior art noted above be solved or addressed in order to fall within the scope of the present invention.

### BRIEF DESCRIPTION OF THE DRAWINGS

The preferred and other embodiments are shown in the accompanying drawings in which:

FIG. 1 is a computer network or similar digital processing environment in which a multiple simultaneous biometric data acquisition and display system can be implemented according to an exemplary embodiment disclosed herein;

FIG. 2 is an alternate computer network or similar digital processing environment in which a multiple simultaneous biometric data acquisition and display system can be implemented according to an exemplary embodiment disclosed herein;

FIG. 3 is a block diagram of the internal structure of a computer (e.g., client processor/device 22 or server computers 30) used in the computer network of FIG. 1 and FIG. 2;

FIG. 4 is a block diagram of the multiple simultaneous biometric data acquisition and display system according to an exemplary embodiment disclosed herein;

FIG. 5 is a detailed schema for the data store used in the multiple simultaneous biometric data acquisition and display system of FIG. 4;

FIG. 6 is a set of data diagrams of the structured data objects transferred between components of FIG. 4;

FIG. 7 is a flow chart of a computer-implemented process of gathering, transforming and presenting biometric data from multiple remote study stations in real-time according to an exemplary embodiment disclosed herein;

FIG. 8A through FIG. 8F is a flow chart of a computer-implemented process for multiple simultaneous biometric data acquisition and display according to an exemplary embodiment disclosed herein;

FIG. 9 is a screenshot of a project load dialog in the study manager application of FIG. 4 according to an exemplary embodiment disclosed herein;

FIG. 10 is a screenshot of a settings dialog in the study manager application of FIG. 4 according to an exemplary embodiment disclosed herein;

FIG. 11 is a screenshot of a stimulus video selection browse dialog in the study manager application of FIG. 4 according to an exemplary embodiment disclosed herein;

FIG. 12 is a screenshot of a participant meta-data creation and editor dialog in the study manager application of FIG. 4 according to an exemplary embodiment disclosed herein;

FIG. 13 is a screenshot of a participant list dialog in the study manager application of FIG. 4 according to an exemplary embodiment disclosed herein;

FIG. 14 is a screenshot of a participant connection status list dialog in the study manager application of FIG. 4 according to an exemplary embodiment disclosed herein;

FIG. 15 is a screenshot of a remote connections dialog in the study manager application of FIG. 4 according to an exemplary embodiment disclosed herein;

FIG. 16 is a screenshot of a participant connection status list dialog after initiating the listener service in the study manager application of FIG. 4 according to an exemplary embodiment disclosed herein;

FIG. 17 is a screenshot of a remote study application on a remote study station of FIG. 4 according to an exemplary embodiment disclosed herein;

FIG. 18 is a screenshot of a proprietary biometric device tracking interface on a remote study station of FIG. 4 according to an exemplary embodiment disclosed herein;

FIG. 19 is a screenshot of a participant connection status list in the study manager application of FIG. 4 with one remote study station reporting a connected biometric device according to an exemplary embodiment disclosed herein;

FIG. 20 is a screenshot of a calibration command dialog in the study manager application of FIG. 4 according to an exemplary embodiment disclosed herein;

FIG. 21 is a screenshot of a proprietary biometric device calibration interface on a remote study station of FIG. 4 according to an exemplary embodiment disclosed herein;

FIG. 22 is a screenshot of a participant connection status list in the study manager application of FIG. 4 with one remote study station reporting successful calibration of a biometric device according to an exemplary embodiment disclosed herein;

FIG. 23 is a screenshot of a remote study station of FIG. 4 displaying a stimulus video according to an exemplary embodiment disclosed herein;

FIG. 24 is a screenshot of a the real-time display of simultaneous multi-participant biometric data in the study manager application of FIG. 4 according to an exemplary embodiment disclosed herein;

FIG. 25 is a screenshot of a the real-time display of simultaneous multi-participant biometric data in the study manager application of FIG. 4 during novice to expert training according to an exemplary embodiment disclosed herein;

FIG. 26 is a screenshot of a real-time display of isolated novice and expert biometric data in the study manager application of FIG. 4 during novice to expert training according to an exemplary embodiment disclosed herein;

### DETAILED DESCRIPTION OF THE PREFERRED AND OTHER EMBODIMENTS

Broadly, this disclosure is directed towards a method and system for multiple simultaneous biometric data acquisition and display. The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Certain embodiments of the invention are described with reference to methods, apparatus (systems) and computer program products that can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Depending on the embodiment, certain acts, events, or functions of any of the methods described herein can be performed in a different sequence, can be added, merged, or left out all together (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. Moreover, in certain embodiments, acts or events can be performed on alternate tiers within the architecture.

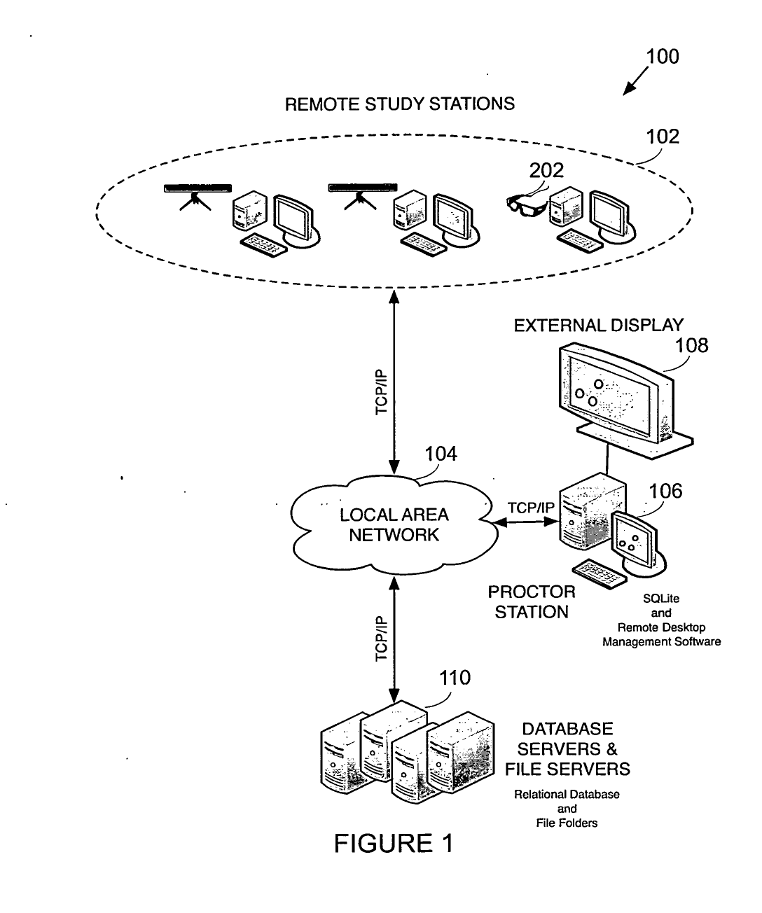

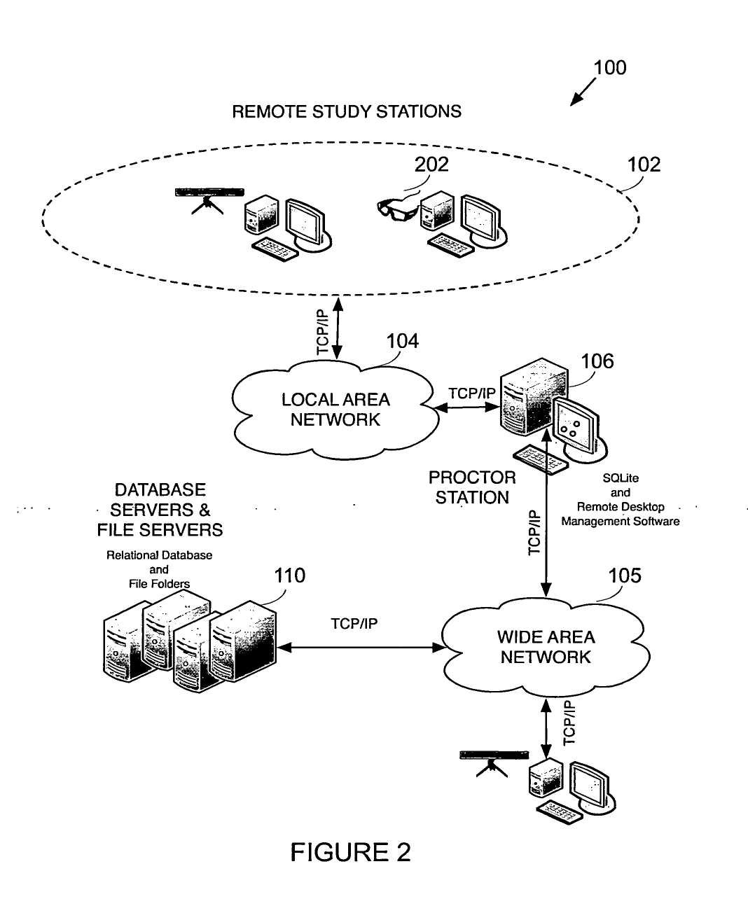

With reference to FIG. 1, a computer network or similar digital processing environment in which the system and method disclosed can be implemented. With reference to FIG. 2, an alternate architecture to accomplish the same objects can be implemented. The present systems and methods can also run on different architectures that include a LAN, WAN, Stand-alone PC, stand-alone, clustered, or networked mini or mainframe computers, etc.

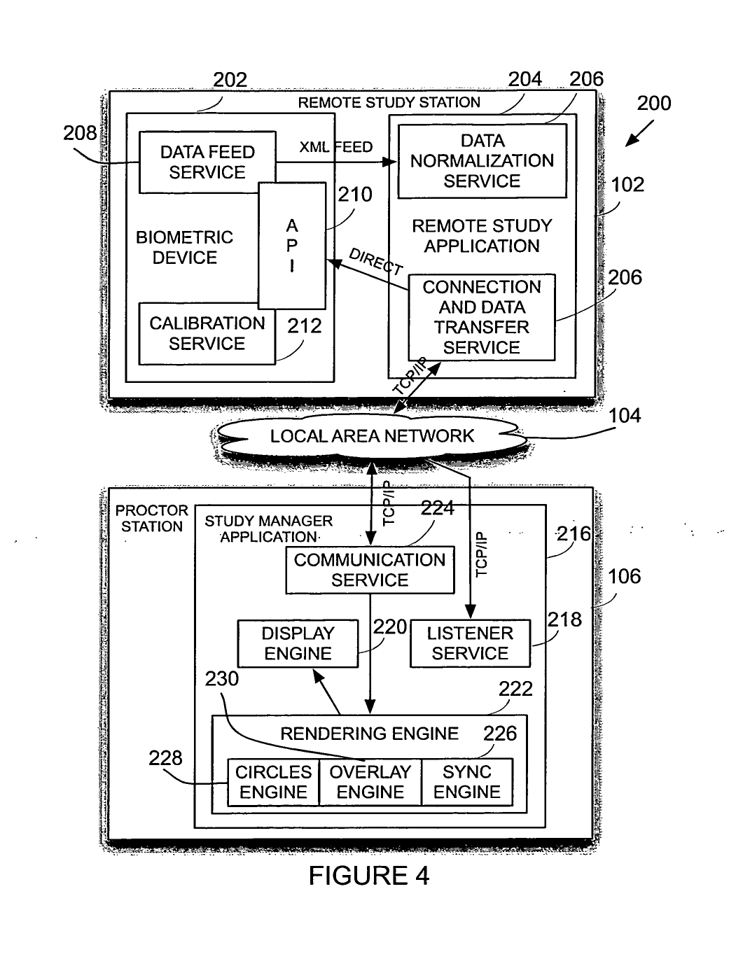

The multiple simultaneous biometric data acquisition and display system in FIG. 4 is distributed on multiple computers and devices 102, 106, 110, 202 according to an exemplary embodiment. In some embodiments, a proctor station 106 runs an instance of the study manager application 216 and SQLite cross-platform SQL database engine. In an alternate embodiment, computers are deployed as virtual instances rather than physical computers. In some embodiments, the proctor station 106 runs an instance of remote desktop management software such as Citrix®, and the remote study stations 102 run the corresponding client software.

FIG. 1 and FIG. 2 are representative of many specific computing arrangements 100 that can support the system and method disclosed. In one embodiment, the software implementing the multiple simultaneous biometric data acquisition system 200 runs in the Microsoft Windows® environment. In another embodiment, the software is implemented to run in other environments, such as UNIX®, Linux®, or in any hardware having enough power to support timely operation of the software shown in FIG. 1, FIG. 2 and FIG. 4.

With reference to both FIG. 1 and FIG. 2, client computers of various types 102 connect to the proctor station 106 via the local area network 104 or a wide area network 105 over the TCP/IP protocol. All computers 102, 106, 110 communicate with each other using the TCP/IP protocol and pass information as structured files, structured data streams such as XML, structured data objects and structured messages. All computers 102, 106, 110 support connections to external devices such as external displays 108 and biometric data collection devices 202.

Client computer(s) and devices 102, 106, 202 and server computer(s) 110 provide processing, storage, and input/output devices executing application programs. Client computer(s) 102 can run both a remote study application and proprietary biometric device software applications. Client computer(s) 102 can also be linked through communications network 104, 105 to other computing devices, including other client devices/processes 102 and server computer(s) 110. In some embodiments, server computer(s) 110 run software to implement centralized data storage and retrieval. In other embodiments, proctor stations 106 run an instance of a local database engine for data storage. Local area network 104 and wide area network 105 can be part of a remote access network, a global network (e.g., the Internet), a worldwide collection of computers, and gateways that currently use respective protocols (TCP/IP, UDP, etc.) to communicate with one another. The remote study stations 102 and the proctor station 106 are interconnected via the communication network 104. Multiple instances of the remote study stations may operate in the biometric data acquisition system simultaneously.

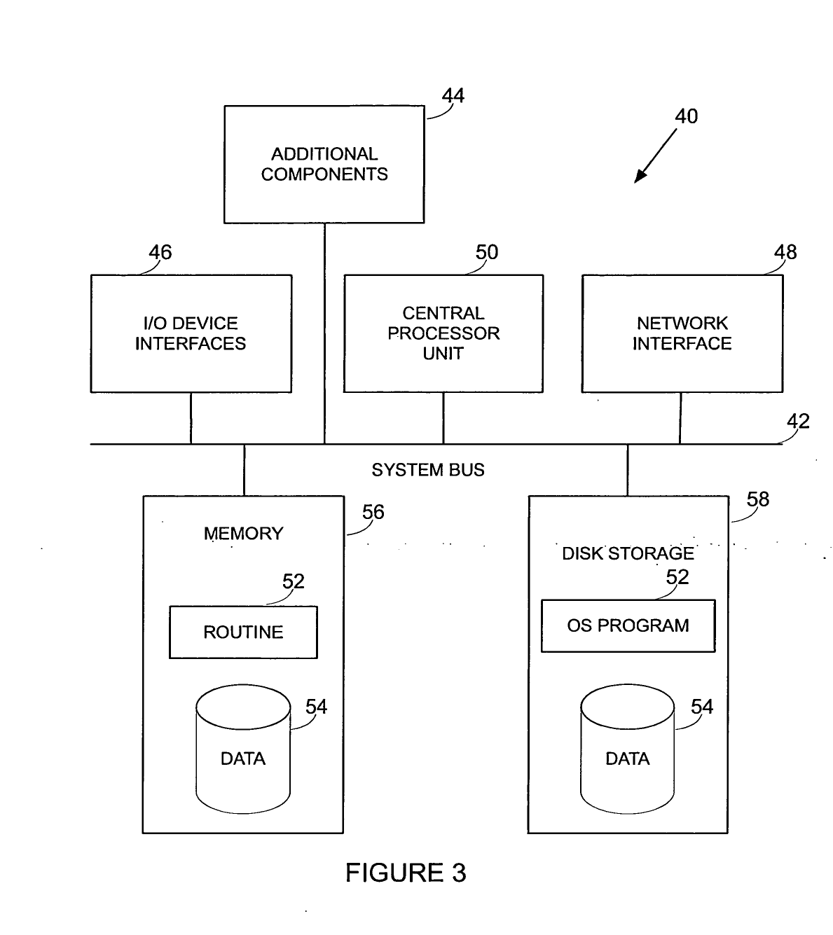

With reference to FIG. 3, each component of the system 40 is connected to system bus 42, providing a set of hardware lines used for data transfer among the components of a computer or processing system. Also connected to bus 42 are additional components 44 of the multiple simultaneous biometric data acquisition and display system 200 such as additional memory storage, digital processors, network adapters and I/O devices. Bus 42 is essentially a shared conduit connecting different elements of a computer system (e.g., processor, disk storage, memory, input/output ports, network ports, etc.) and enabling transfer of information between the elements. I/O device interface 46 is attached to system bus 42 in order to connect various input and output devices (e.g., keyboard, mouse, displays, printers, speakers, etc.) to the multiple simultaneous biometric data acquisition and display system 100. Network interface 48 allows the computer to connect to various other devices attached to a network (e.g., local area network 104 of FIG. 1). Memory 56 provides volatile storage for computer software instructions 52 and data 54 used to implement methods employed by the system disclosed herein. Disk storage 58 provides non-volatile storage for computer software instructions 52 and data 54 used to implement an embodiment of the present disclosure. Central processor unit 50 is also attached to system bus 42 and provides for the execution of computer instructions.

In one embodiment, the processor routines 52 and data 54 are a computer program product, including a computer readable medium (e.g., a removable storage medium such as one or more DVDROM's, CD-ROM's, diskettes, tapes, etc.) that provides at least a portion of the software instructions for the system. Computer program product that combines routines 52 and data 54 may be installed by any suitable software installation procedure, as is well known in the art. In another embodiment, at least a portion of the software instructions may also be downloaded over a cable, communication and/or wireless connection.

With reference now to FIG. 4, a multiple simultaneous biometric data acquisition system 200 enables collection of biometric data from multiple remote study stations 102 and real-time display of biometric data overlaid on a stimulus video at the proctor station 106. A remote study application 201 runs on each remote study station 102. One or more biometric devices 202 are connected to the remote study station 106 and allow access to the biometric device functions through an API 210. In some embodiments, the remote study application 204 validates whether a biometric device is loaded, requests calibration of a biometric device, and requests transfer of biometric information. In some embodiments, the proprietary biometric device provides a direct API to pull biometric data or request a stream or feed of biometric data. In other embodiments, the data is written to a flat file and the remote study application 204 monitors the flat file for changes. The proprietary biometric device implements a calibration service 212 that is callable using the API 210.

The remote study application 204 resides on the proctor station 106 and implements a data normalization service 206 that normalizes the raw biometric data provided by the biometric device 202. This data normalization service 206 normalizes, categorizes and packages the data for delivery to the study manager application 216. Messages containing biometric data and other information are sent via TCP/IP to a pre-configured socket on the study manager application 216. A communication service 224 is implemented on the study manager application 216 to send and receive messages to and from remote study applications 204. A listener service 218 is implemented as part of the study manager application 216 that monitors the connection, device and calibration status of remote study stations 102. Biometric data received from remote study stations 102 is received by the communication service 224 and stored in memory until completion of the study. The biometric data is accessed from memory in real-time by the rendering engine 222. The rendering engine includes a circles engine 228, overlay engine 230 and sync engine 226 which, in combination, provide the necessary data to the display engine 220 such that multiple simultaneous biometric data streams can be displayed in real-time. In some embodiments, the display engine and rendering engine can include proprietary and open source technologies and multimedia frameworks such as DirectShow®, MATLAB®, and OpenCV®.

In some embodiments, upon successful receipt of all biometric data for a particular study run for a given remote study station 102, the data for that station's run is written to a data store. In certain embodiments, that data store is a database file stored in the associated project folder on the proctor station 102. In other embodiments, that data store is a centralized database hosted on a database server. In some embodiments, the stimulus video is stored as a discreet video file in the project folder.

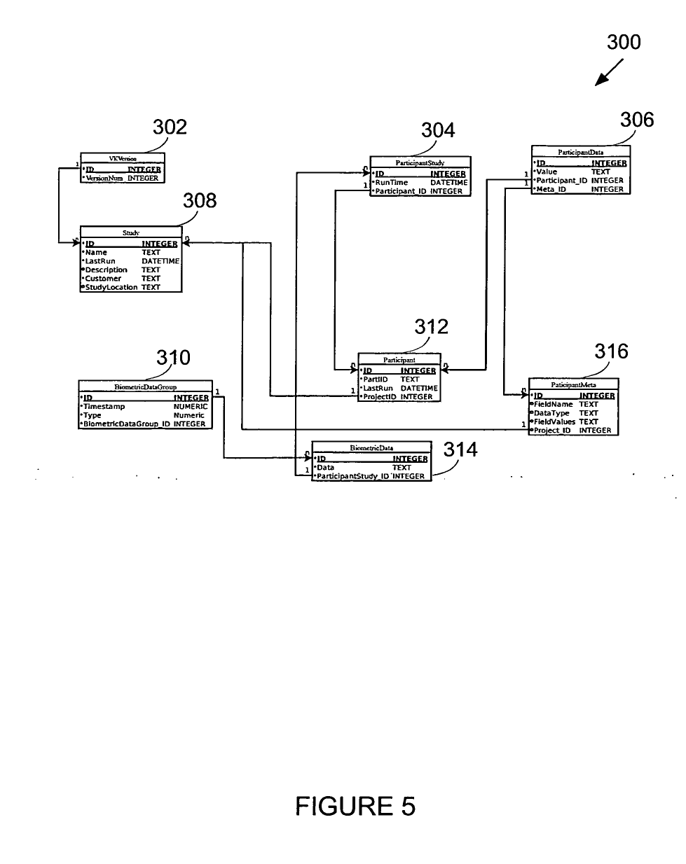

With reference to FIG. 5, a detailed schema 300 is described for implementing the data model for the multiple simultaneous biometric data acquisition system 200 according to an exemplary embodiment. The tables and relationships contained in the schema 300 are Maintained in a data store by the study manager application 216. The VKVersion table 302 contains version number information that, in some embodiments, can be used to synchronize all computers to the same software level. Each record in the VKVersion table includes values for ID and VersionNumber. ID is a unique integer representing a unique row in the table. VersionNumber is an integer representing a particular software version.

A Study table is the highest-level table and there is one discreet table for each project. This table contains information specific to the study. The table consists of a single record that includes values for ID, Name, LastRun, Description, Customer and StudyLocation. LastRun, Description, Customer and StudyLocation allow for NULL values. ID is an integer value representing a unique entry in the table. Name is a user-friendly string identifying the study, as well as the folder name on the proctor station 106 containing all project-related data. This value cannot be Null. LastRun is a system-generated DateTime value indicating the data and time of the last run of the study for a any participant. Description, Customer and Study Location are optional text fields describing details of the study.

A Participant table 312 identifies and describes each participant in a study. The table consists of multiple records that include values for ID, PartID, LastRun and ProjectID. ID is an integer value representing a unique entry in the table. PartID is a user-friendly text entry identifying a participant. This value cannot be NULL. LastRun is a system-generated DateTime value indicating the data and time of the last run of the study for a particular participant. ProjectID is an ID value in the Study table that links the participant to a study.

A ParticipantMeta table 316 defines the meta-data that can be associated with each participant in the project. The table consists of multiple records that include values for ID, FieldName, DataType, FieldValues and ProjectID. ID is an integer value representing a unique entry in the table. FieldName is the user-friendly text that identifies a particular meta-data field. DataType is a text field that identifies the type of data that can be entered. FieldValues contain the allowable text values for the meta-data field. If FieldValue is blank, any data is allowed. Project_ID is an ID value in the Study table that links the meta-data definition to a study.

A ParticipantData table 306 stores the meta-data information for each participant. The table consists of multiple records that include values for ID, Value, Participant_ID and Meta_ID. ID is an integer value representing a unique entry in the table. Value stores the value entered for a particular meta-data field. The Meta_ID value is an ID from the ParticipantMeta table, and identifies the meta-data field with which the value in the entry is associated. Participant_ID is an ID value from the Participant table that identifies the participant with which the meta-data entry is associated.

A ParticipantStudy table 304 records the history of study runs for a particular participant. The table consists of multiple records that include values for ID, RunTime and Participant_ID. Each entry corresponds to a single run of the study for single participant. ID is an integer value representing a unique entry in the table. RunTime is DateTime value that identifies the last time the participant ran the study to completion. Participant_ID is an ID value from the Participant table that identifies the participant with which the study run is associated.

A BiometricDataGroup table defines the list of data items to be recorded in the BiometricData table. The table consists of multiple records that include values for ID, Timestamp, Type and BiometricDataGroup_ID. ID is an integer value representing a unique entry in the table. Timestamp stores the date and time a biometric data item is recorded. Type is the descriptor for a particular type of biometric data item. BiometricDataGroup_ID is used as a key value to relate this table to the entries in the BiometricData table.

A BiometricData table contains the normalized data collected by the biometric devices. The table consists of multiple records that include values for ID, Data and ParticipantStudy_ID. ID is an integer value representing a unique entry in the table. Data contains a single normalized biometric data item, for example, a single normalized eyeX coordinate. ParticipantStudy_ID is an ID value in the ParticipantStudy table associating an entry with a particular study.

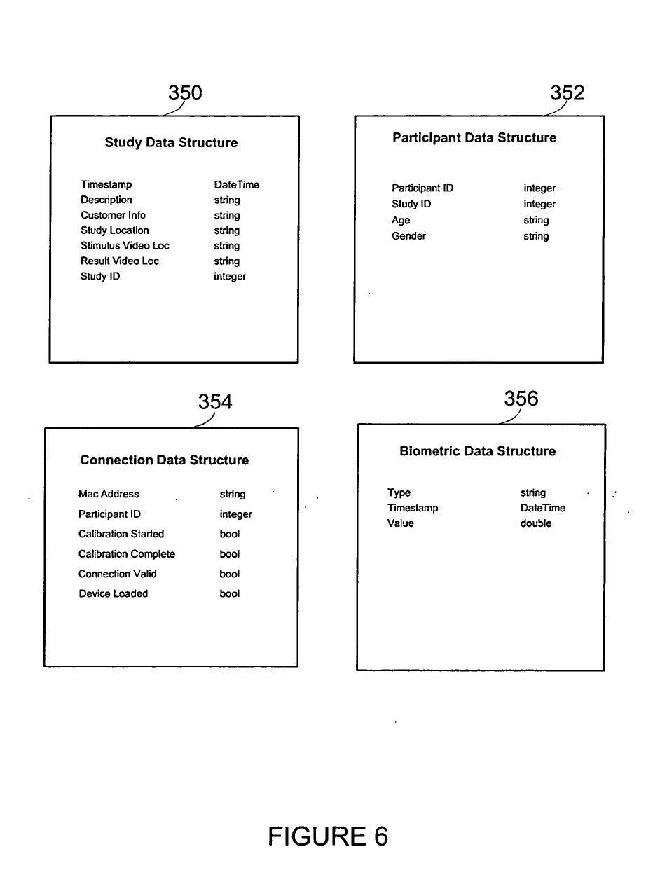

Referring now to FIG. 6, examples of multiple simultaneous biometric data acquisition system data structures are disclosed. The study data structure 350 is constructed from information contained in the Study table, as well as additional information. In some embodiments, the locations of the stimulus video, an output video or both are ascertainable by virtue of their residing in the same folder as the data store. This data structure is used for populating the user interface of the study manager application 216, including the settings window 700. Similarly, the participant data structure 352 results from a join of the various participant tables 304, 306, 312, 316 and is used to populate the participants window 900 in the study manager application 216. The connection data structure 354 is the format used to deliver connection status messages to the study manager application 216, which parses the message and populates the status window 1000 accordingly. In some embodiments, the information in this data structure is in-memory information and is not retrieved from a data store.

In some embodiments, the multiple simultaneous biometric data acquisition system 200 obtains gaze information from one or more eye tracking biometric devices. This raw biometric data is normalized, augmented and packaged prior to sending to the proctor station 106, resulting in a type of distributed pre-processing of aggregate gaze data. In the case of gaze data, the x coordinate data and y coordinate data retrieved are each converted to values between 0 and 1. The value corresponds to a location on the video canvas defined by setting the lower-most left point of the video canvas to 0,0 and the upper-most point of the video canvas to 1,1. In an alternate embodiment, a different normalization model is used. The conversion algorithm will vary based on the format of the gaze data generated by a particular biometric device. For example, in some embodiments, the raw gaze data will be converted to the normalized format by dividing the x coordinate value by the width of the video canvas, and the y coordinate value by the height of the video canvas. If the width of the canvas is 1024 pixels, and the height of the canvas is 800 pixels, and if the (x,y) data generated from the biometric device is x=395 an y=294, the normalized values for x and y would be calculated as follows:

eyeX value: 395/1024=0.3857

eyeY value: 294/800=0.3675

The eyeX and eyeY values now correspond to a specific location relative to the defined stimulus video canvas. Each value is sent to the proctor as a discreet message using the Biometric Data Structure 356. The Type is a string identifying the type of data that can be used by the study manager application 216 to determine what to do with the data. In this case, the types are eyeX and eyeY, which indicates to the study manager application the data is either the normalized x coordinate or the normalized y coordinate and that the data can be used for rendering and displaying circles, and for storage and post-study analysis. The Timestamp is the number seconds since the beginning of the video. In some embodiments, this information is used by the study manager application to synchronize the data streams in terms of associating all eyeX and eyeY data from remote study stations 102 with the correct video frame of the stimulus video. In an alternate embodiment, synchronization is done by counting frames and then, based on the known framerate, calculating the correspondence between the stimulus video frame and a given eyeX and eyeY coordinate based on the number of messages received from a given biometric device. The Value is a double that represents the eyeX or eyeY normalized coordinate value, such as in the above example.

Normalized gaze data from remote study stations 102 is then used by the rendering engine 222 to generate real-time display of multiple simultaneous biometric data feeds. The rendering engine 222 includes a circle engine that generates a circle using the equation of a circle with radius r and center (eyeX, eyeY), where r can vary across different embodiments. The sync engine 226 associates the circles with the corresponding frame of the stimulus video as described previously, and the overlay engine 230 overlays the circles on the video frame based on the output of the circles engine and the state of the biometric data display settings for that participant. The frames are sent to the display engine 220 one frame at a time for real-time video playback either on the proctor station 216 display, on an external display 108, or both.

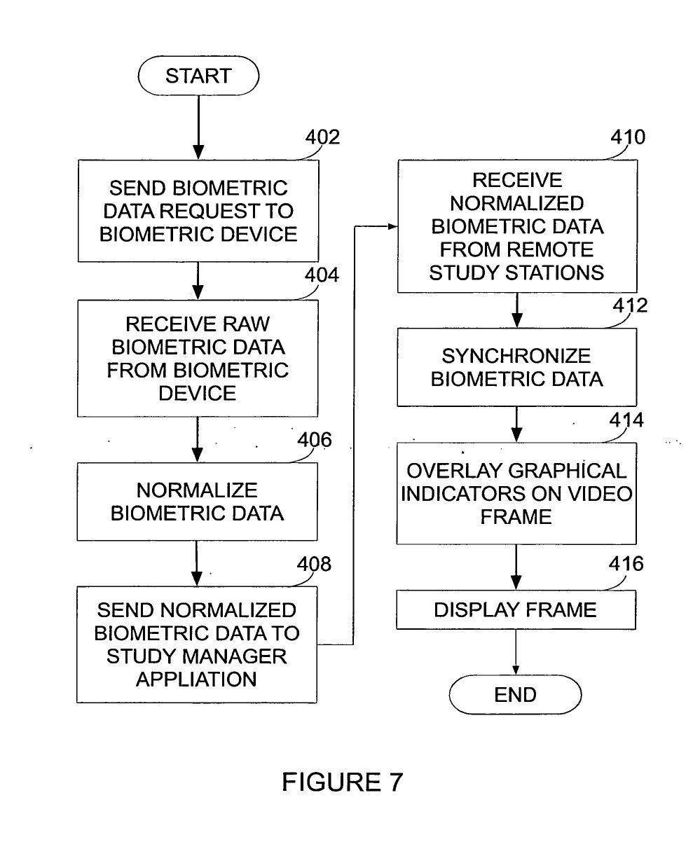

FIG. 7 is a data flow diagram of one embodiment of a technique for collecting and presenting multiple simultaneous biometric data in real-time. The example of FIG. 7 results in a synchronized display of biometric data from multiple remote study stations overlaid on a stimulus video in real-time. In one embodiment, the flow of FIG. 7 is accomplished by an electronic system, for example, the electronic systems of FIG. 1 or FIG. 2; however, any combination of hardware, software or hardware and software can be used.

A request is sent by the remote study application 201 to the biometric device 202 requesting biometric data 402. This data can be, for example, gaze tracking data in the form of raw x and y coordinates In some embodiments, the biometric device 202 simply writes data to a flat file, in which case, the request is nothing more then a check of whether or not the flat file has been modified by the biometric device 202.

The raw biometric data is received by the remote study application 201 and normalized 404, 406 by the data normalization service 206 as discussed previously. The normalization algorithms are specific to the data format generated by a given biometric device 202.

Once normalized, the biometric data is sent to the study manager application 216, 408. Upon receiving the normalized biometric data 410, the study manager application 216 synchronizes the data with biometric data 412 from other remote study stations 102. In some embodiments, a timestamp value in the data message indicates the time since the stimulus video began. This correlates with a particular video frame, thus all data from all remote study stations 102 can be plotted on the correct video frame.

Graphical indicators are generated and overlaid on the video frame 414. In the case of gaze data, for example, colored circles can be generated indicating a gaze location and helping to identify to which participant or category of participants the gaze indicator belongs. Once the overlay data is obtained, the data is sent to the display engine 220 and the frame is displayed 416. The process is repeated for each frame until the stimulus video has run to completion.

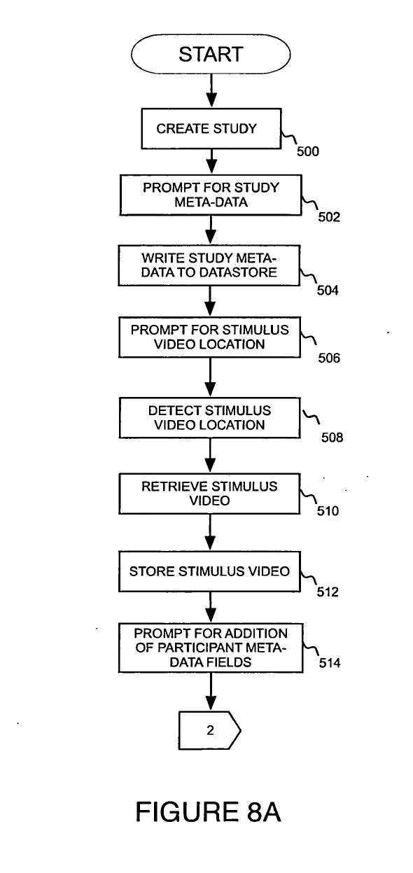

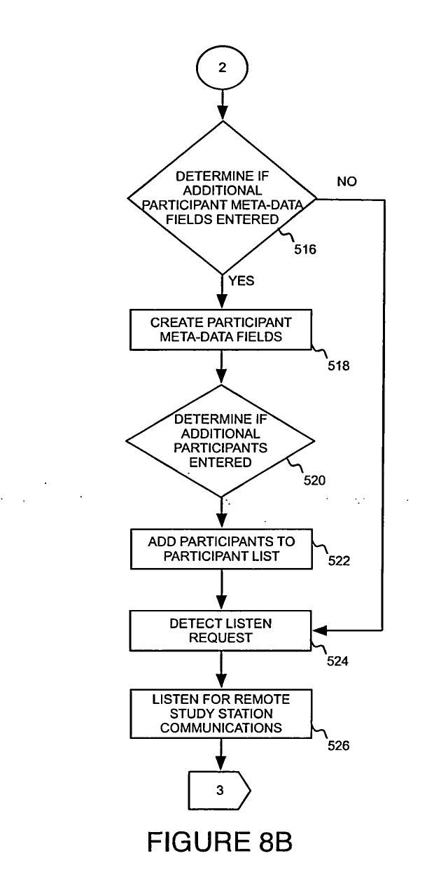

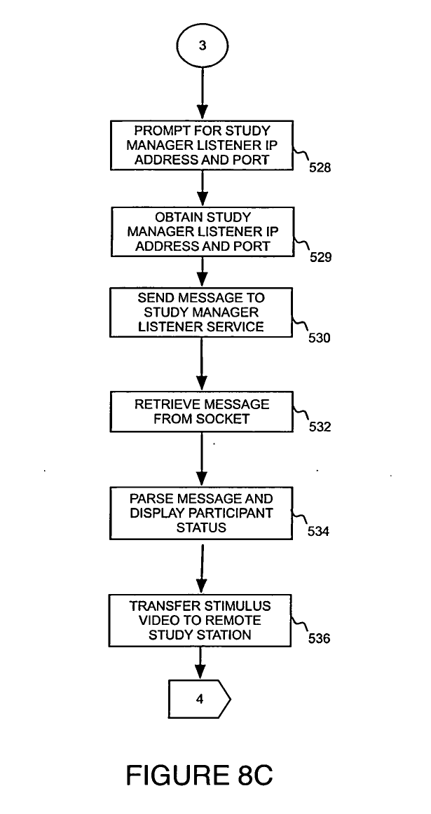

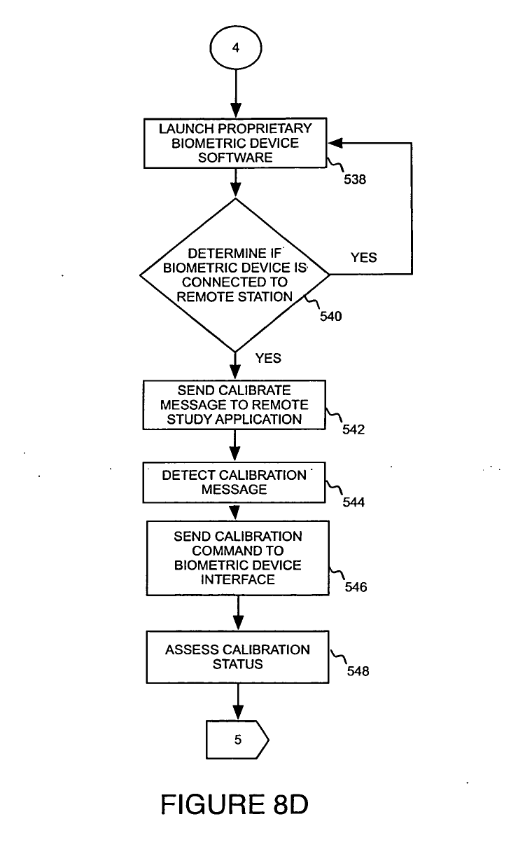

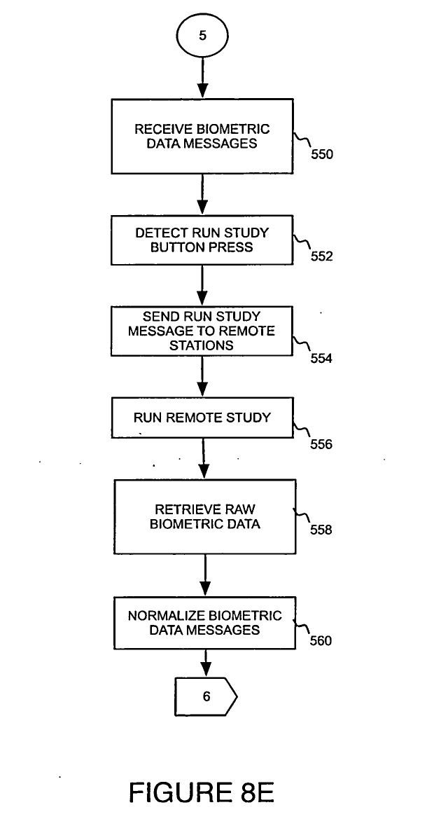

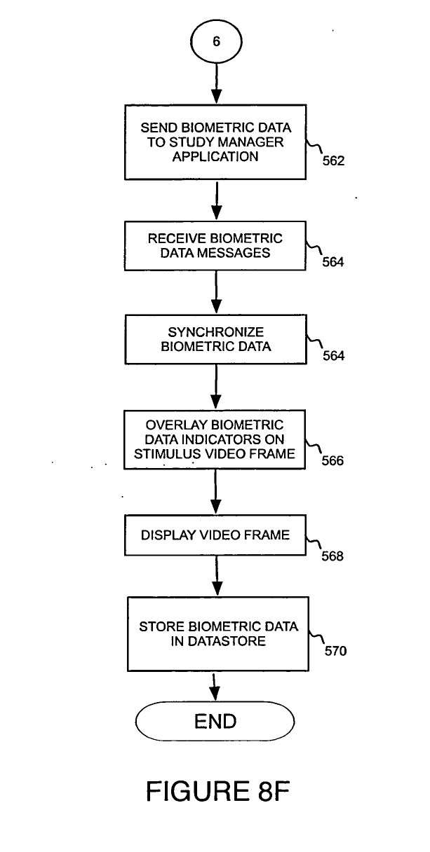

Referring now to FIG. 8A through FIG. 8F, an exemplary embodiment of a computer-implemented process for the collection and presentation of biometric data is disclosed. A project is created 500 and the associated meta-data values are obtained and written to the data store 502, 504. A stimulus video is located, retrieved and stored locally, in a database or at some other appropriate location 506, 508, 510, 512. Additional study meta-data fields and participant meta-data fields are optionally created 514, 516, 518. Participants are added to the study and the listening service is activated 522, 524, 526. The remote study application 201 determines the study manager application 216 IP address and port and sends a message indicating connection status 528, 529, 530. The study manager application communication service retrieves the message from the socket, parses the message and updates the participant status window accordingly 532, 534. Upon establishing a successful connection, the stimulus video is transferred to the remote study stations 536.

The remote study application 201 launches connected biometric devices and verifies they are operating and available 538, 540. A calibrate message is sent to the remote study application 201 directing the remote study application to send calibration requests to the biometric device interfaces for selected participants 542, 544, 546. Calibration status is assessed by the remote study application and the status sent to the listener service 548, 549, 218.

The study manager application 216 sends a run study request to selected remote study applications 201. The remote study applications initiate the stimulus video playback and collect raw biometric data 552, 554, 556, 558. The collected data is normalized, packaged and sent to the study manager application 560, 562, 216. Upon receiving the normalized biometric data the data is synchronized with data received from other remote study stations 102 and indicators are plotted on the appropriate video frame for display at the proctor station 564, 566, 568, 106. Once a study has run to completion and data has been successfully received by the study manager application 216, the normalized biometric data is transferred from resident memory to a persistent datastore.

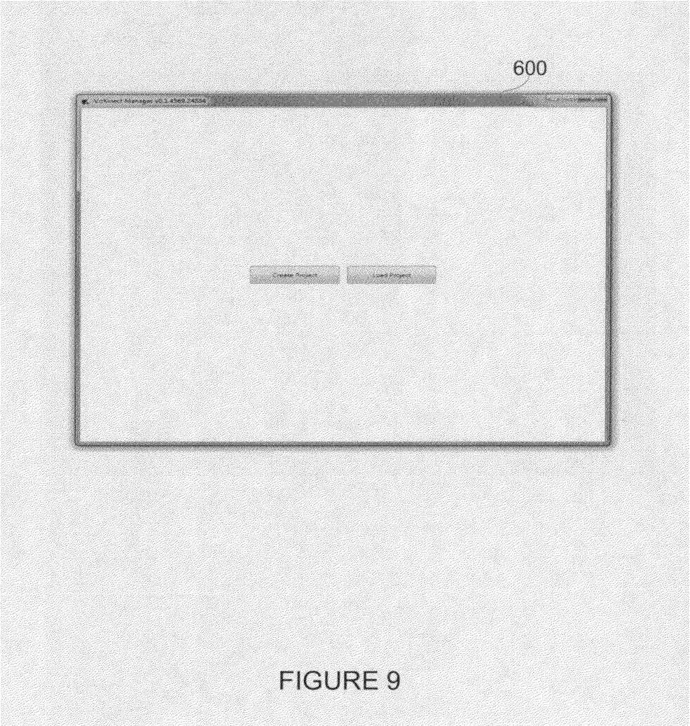

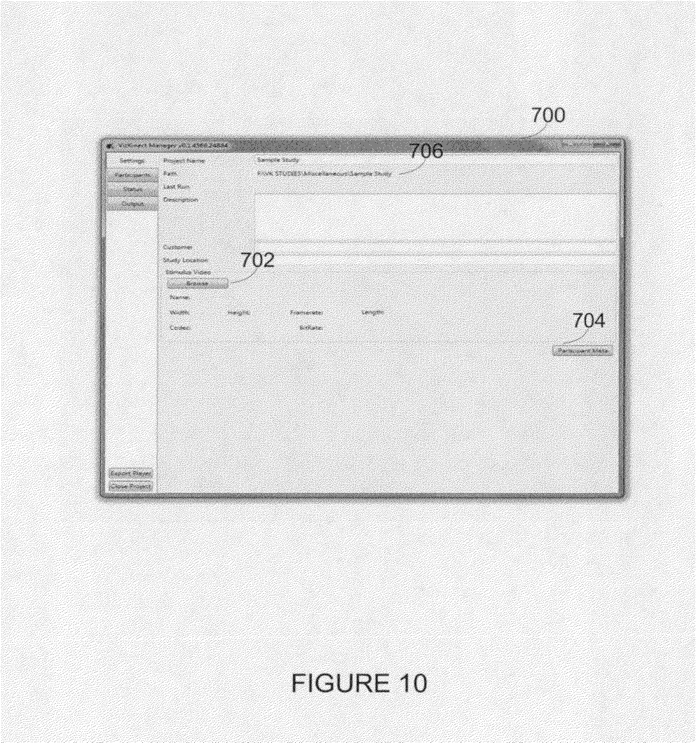

In an exemplary embodiment, the process of for acquiring and displaying biometric data begins with the study proctor loading a project. For the purposes of this disclosure, “study” and “project” are used interchangeably. Referring now to FIG. 9, the study manager application 216 generates a dialog 600 presenting options of either creating a new project or loading an existing project. The settings window shown in FIG. 10 includes information about the project loaded or created, including the project name, the path where the project database is stored, the last time a study was run, an optional description of the project, an optional identification of the customer associated with the project, an optional identification of the physical location where the study occurs, and the stimulus video to be used in the study. In some embodiments, informative attributes relating to the stimulus video are displayed, including the video canvas width and height, the frames per second, the video length, the codec, and the bit rate. In some embodiments, this window further allows the proctor to browse and select the stimulus video 702, and to create additional meta-data fields 704 for parameterized identification and analysis of participants.

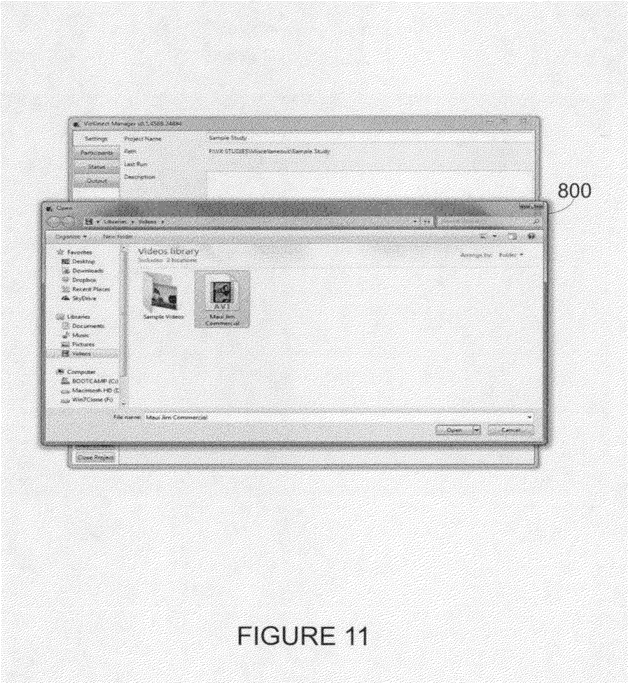

FIG. 11 shows a standard operating system browse dialog 800 generated when clicking the Browse button 702. The proctor can then select the desired stimulus video, which is then copied to the folder where the project database is located 706. In an alternate embodiment, the video is stored in a database.

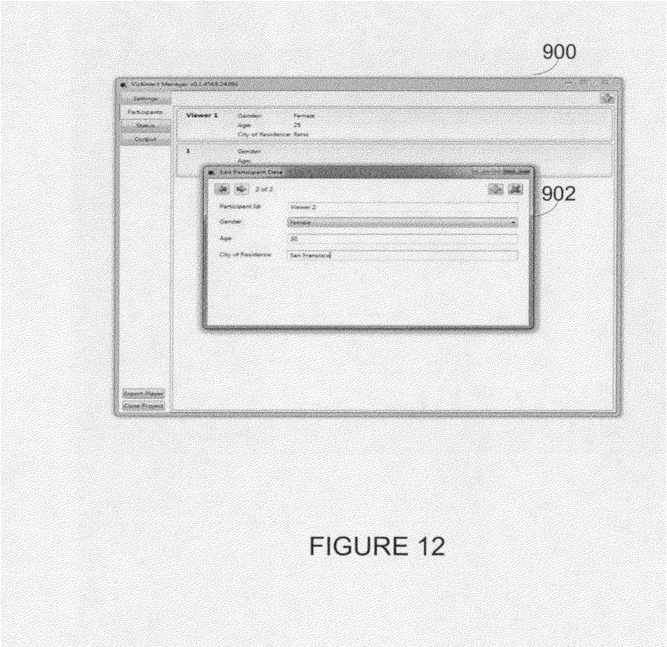

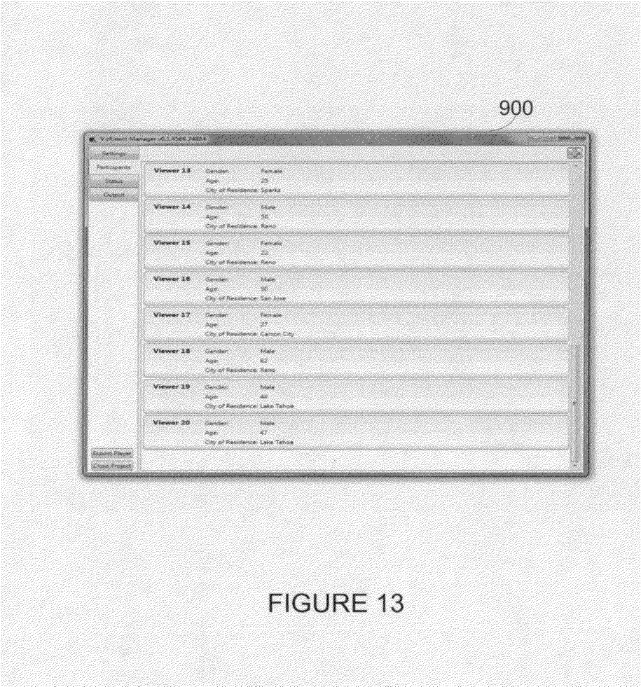

Referring now to FIG. 12, an exemplary embodiment includes an edit participant data dialog 902 that allows the proctor to modify the meta-data attributes for the various participants in the study. This meta-data includes a participant id, as well as any number of additional meta-data fields created by the proctor 704, such as gender, age and city of residence. FIG. 13 shows an instance of the participants window with 20 participants 900. The various meta-data fields are displayed, as well as the value entered for each participant.

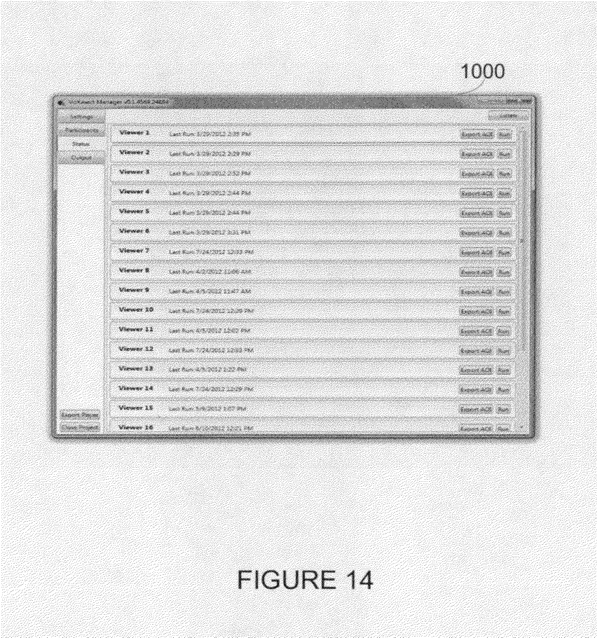

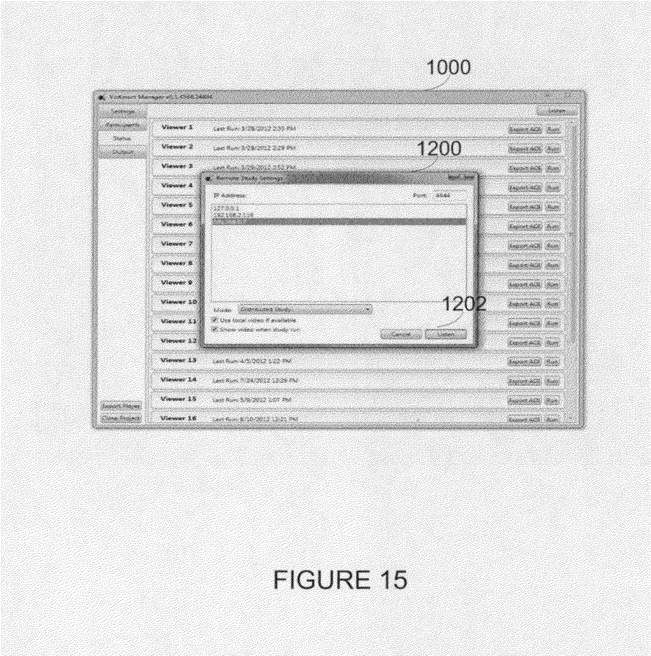

FIG. 14 shows a participant status window 1000 according to an exemplary embodiment. The information shown includes the participant id and the date and time of the last run of the study. This is the display that occurs prior to initiating the listener service 218. This window provides the proctor with the capability of exporting Areas of Interest information, as well as sending a run command to selected remote study applications 201. In some embodiments, a button is included to initiate the listener service 218. FIG. 15 shows a remote study settings dialog for configuring the communication and study preferences 1200. This dialog includes selecting the IP address and port on which the listener service 218 will listen for communication from the remote study stations 201. In some embodiments, the IP addresses are automatically populated based on the addresses assigned to the machine. In other embodiments, the IP address can be set manually. This dialog also includes parameters that direct specific functioning of the study on the remote study stations 102. In some embodiments, these include the study mode and the option to use a local copy of the stimulus video. There is also an option to show the video on the proctor station 106 when the study is running Once these options are selected and the Listen button 1202 clicked, the listener service will begin monitoring the identified port for messages from remote study stations 102.

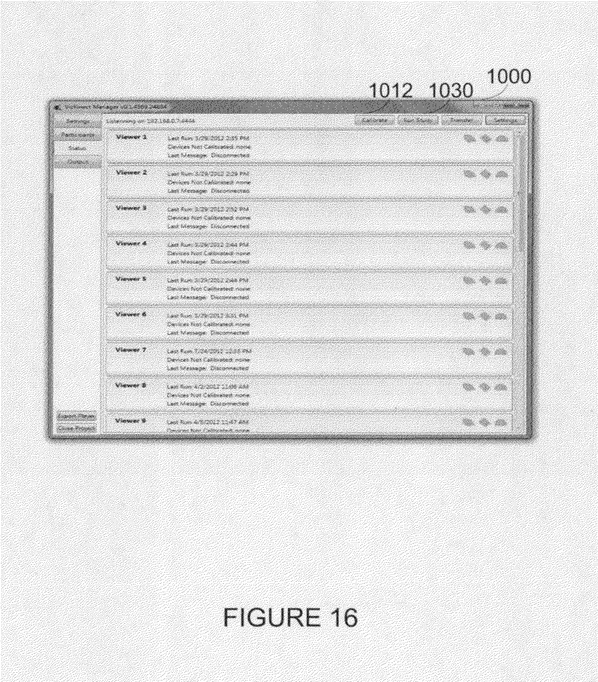

Referring now to FIG. 16, once the listener service 218 is activated, the participant status window 1000 will show additional information and provide additional functionality. In some embodiments, for each participant, the status of the remote study station 102 is shown as well as the specifics of the last message received by the listener service 218. The example of the participant status window 1000 shown indicates that there are no connected remote study stations 102. In some embodiments, calibration command, run study command and transfer command are not available until the appropriate status is reached for one or more of the participants.

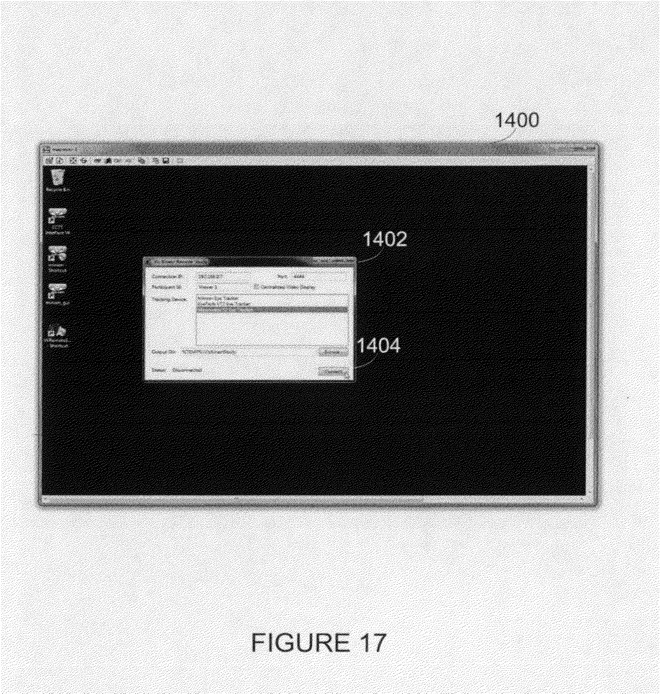

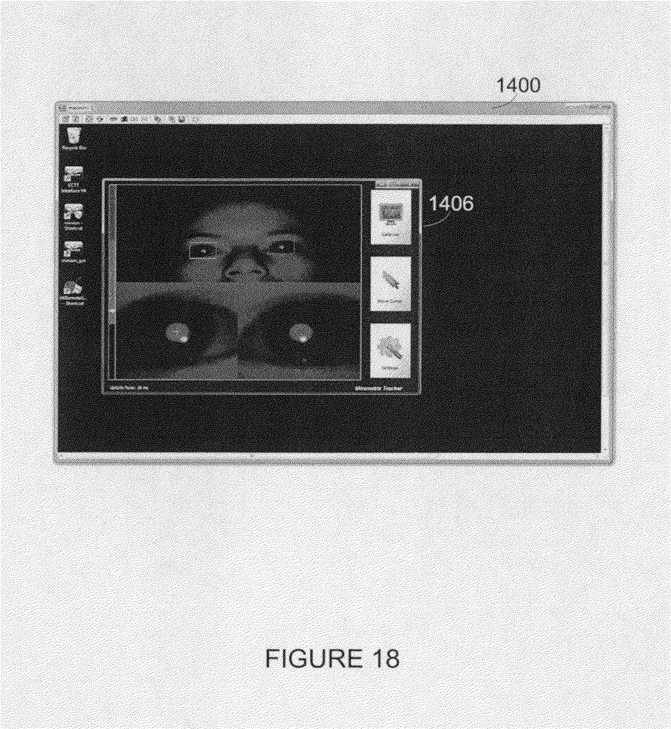

Referring now to FIG. 17, the remote study application 201 is initiated on one or more remote study stations 102. In some embodiments, the remote study application 201 is launched by a remote desktop management application or a screen sharing service, where the proctor is able to interact remotely with the remote study station 1400. The main window of the remote study application 201 allows for configuration of the remote study station 102. In some embodiments, the configuration parameters include the IP address and port on which the listener service 218 is listening for remote study machine 201 communications. The participant id will be sent to the study manager application 106 such that the remote study station 201 can be paired with the appropriate entry in the participant list. A list of supported biometric devices 208 allows the remote study station 102 to be configured for one or more specific devices, ensuring that commands to biometric devices 208 are sent to the appropriate interfaces 210. There is also an output directory selection interface for storage of study data and the stimulus video. The current connection status is displayed as well. Once the parameters are set, the Connect button 1404 is clicked to initiate communications with the listener service 218 and to launch proprietary software 1406 related to the connected biometric devices 208.

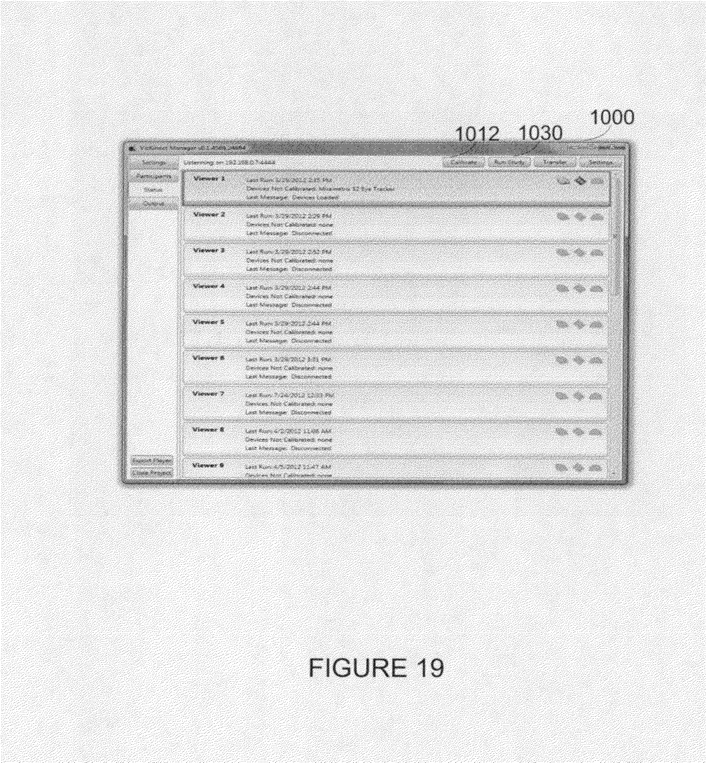

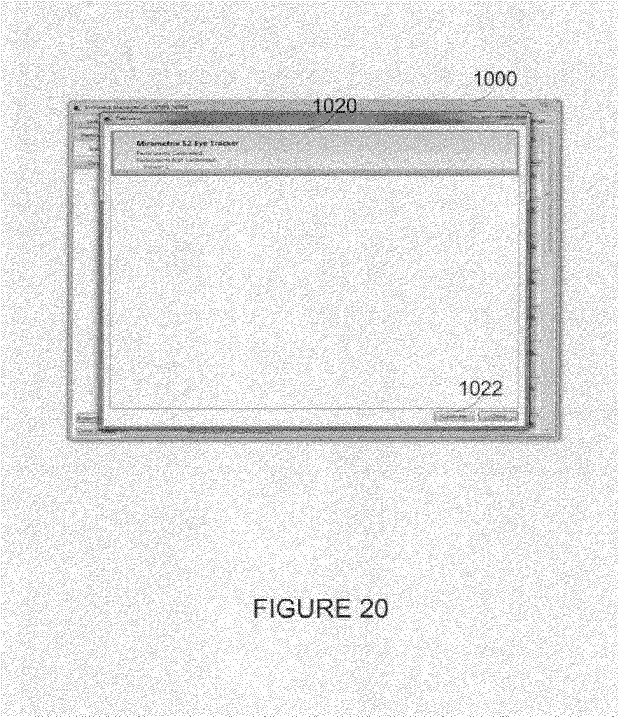

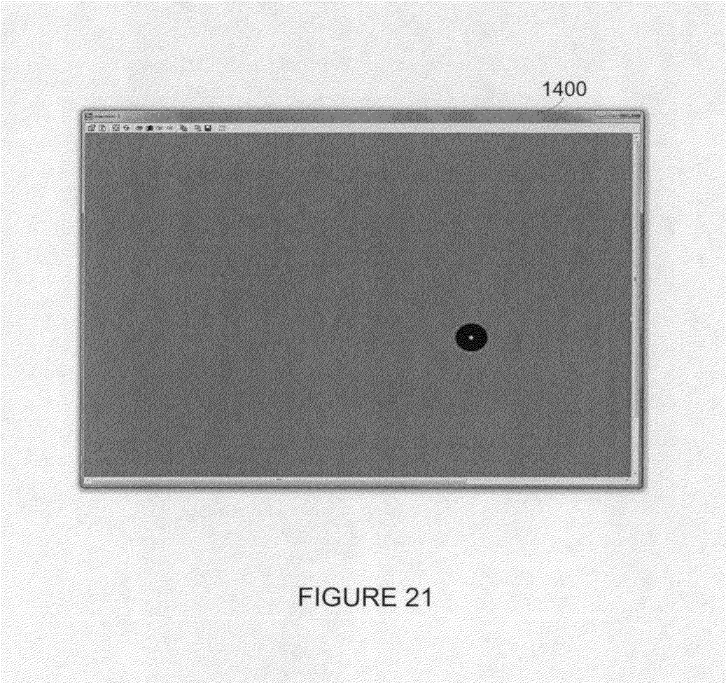

Referring now to FIG. 19, the participant status window 1000 shows one participant is connected, a biometric device 208 is loaded for that participant, and that calibration of that remote study station 102 has not yet occurred. The Calibration button 1012 is enabled, indicating that this is the only function available for the selected participant. FIG. 20 shows the calibration dialog 1020 launched when the Calibration button 1012 is clicked. When the Calibrate button 1012 is clicked, a message is sent to the selected remote study station 102 to request calibration of the biometric device 208 through the appropriate interface 210. FIG. 21 shows a proprietary calibration interface for a biometric eye tracker device launched as result of a calibrate request made by the remote study application 201.

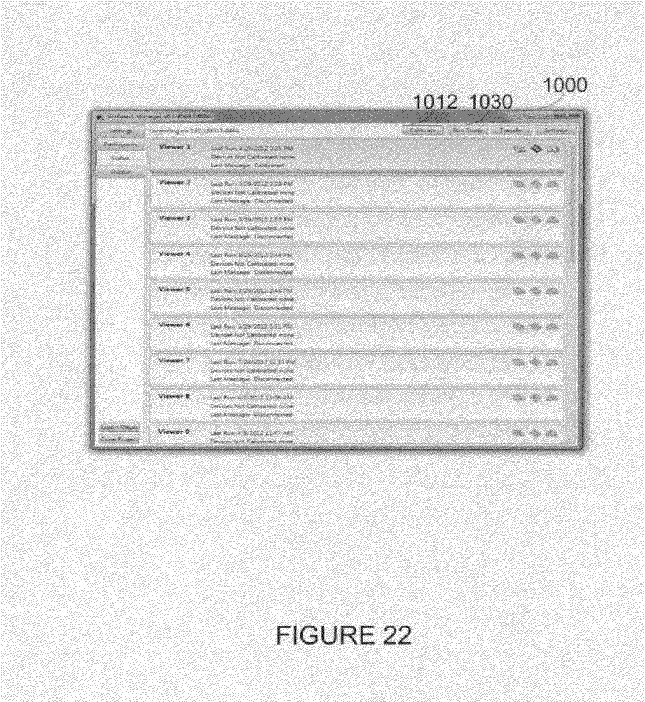

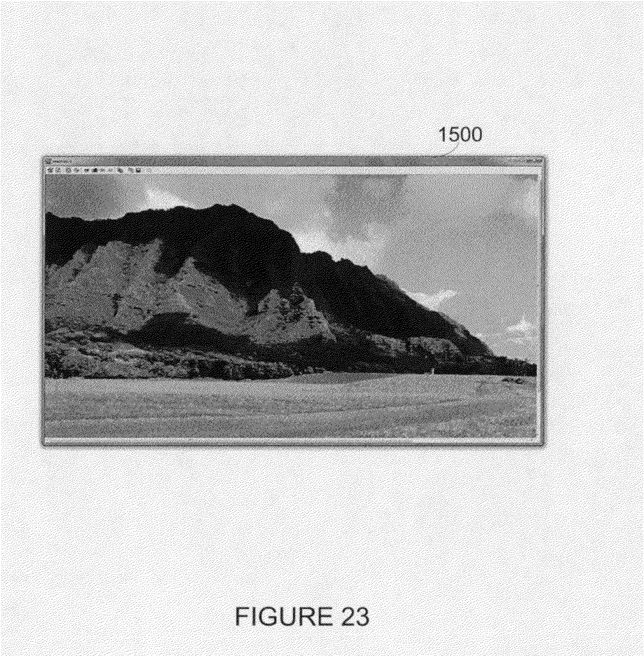

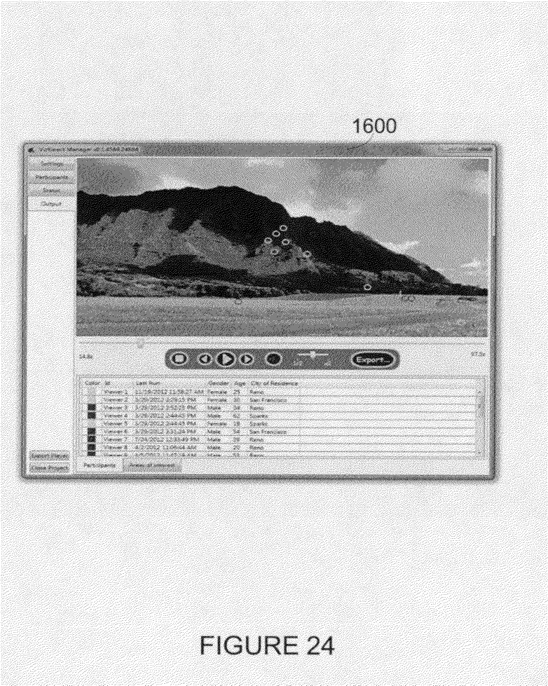

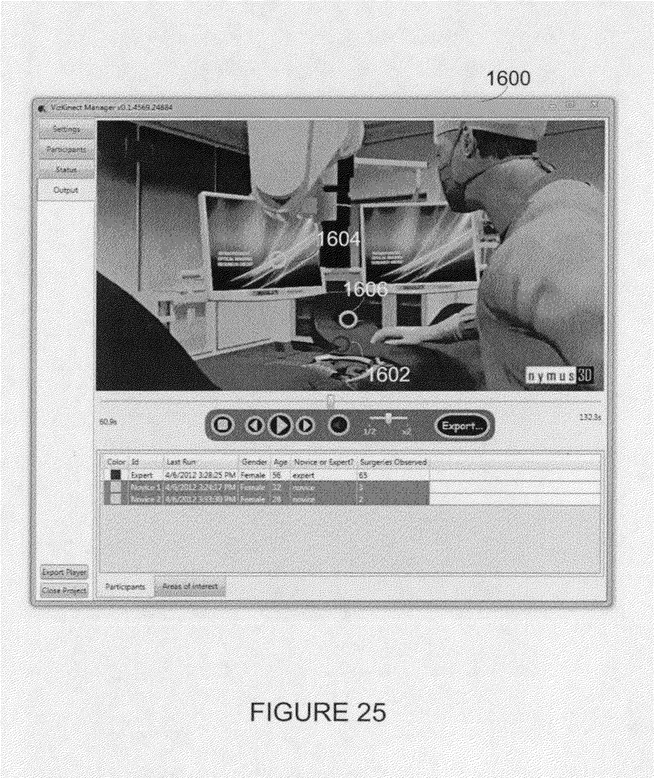

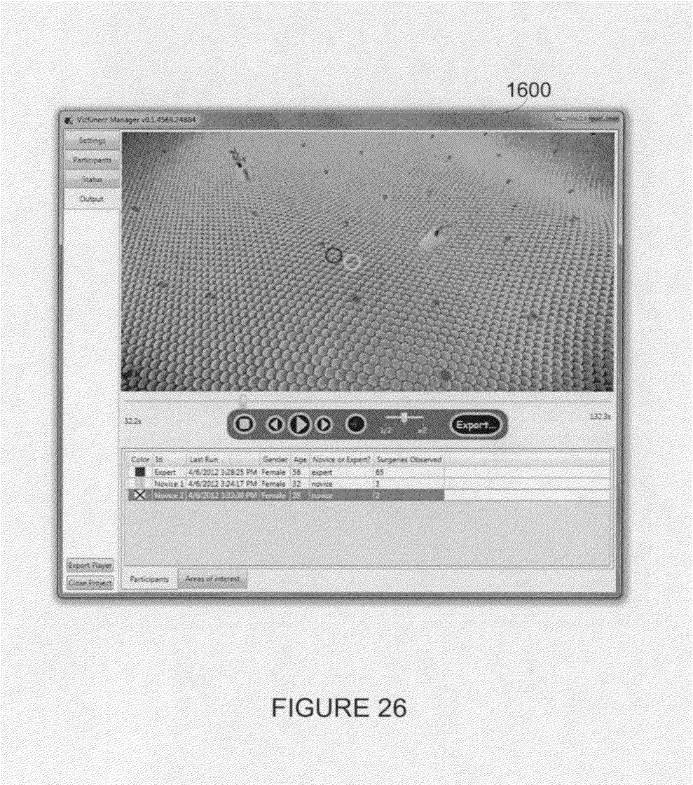

Upon successful calibration, the participant status list is updated as shown in FIG. 22. By clicking on the Run Study 1030 button, a command is sent to the remote study station 102 to start the stimulus video, collect biometric data and send normalized data back to the study manager application 216. FIG. 23 shows the stimulus video running on the remote study station 102. Referring now to FIG. 24, the real-time display of biometric data on the proctor station 106 is shown. Circles corresponding to specific gaze coordinates for specific participants are shown, along with the interface to toggle the display of one or more of the participants. Referring now to FIG. 25, real-time simultaneous display of multiple participants' biometric data is shown in the context of medical training. Here, the gaze information of an expert 1602 is shown along with the gaze information of two novices 1604, 1606. FIG. 26 shows one of the two novice participant's gaze information toggled such that it is not visible, allowing the training to focus on a single trainees performance.

In light of the exemplary embodiment and multiple additions and variations described above, the scope of the present invention shall be determined by the following claims.

We claim:

1. A computer implemented method of acquiring and displaying biometric data in real-time comprising:
collecting a first biometric data item on a first computing device from one or more biometric devices connected to said first computing device;
collecting a second biometric data item on a second computing device from one or more biometric devices connected to said second computing device;
normalizing said first biometric data item on said first computing device;
normalizing said second biometric data item on said second computing device;
sending said first normalized biometric data item to a third computing device;
sending said second normalized biometric data item to said third computing device;
associating said first normalized biometric data item and said second normalized biometric data item with a video frame of a stimulus video on said third computing device;
overlaying one or more graphical indicators corresponding to said first normalized biometric data item and said second normalized biometric data item at specific locations on said video frame on said third computing device;
displaying said video frame with said overlaid graphical indicators.
